(19) United States
(12) Patent Application Publication
(10) Pub. No.: US 2020/0246715 A1
(43) Pub. Date: Aug. 6, 2020

(54) MAGNETIC CONSTRUCTION TOYS

(71) Applicant: Melissa and Doug LLC, Wilton, CT (US)

(72) Inventors: Bernard Bensussan, Strattford, CT (US); Lyndall Fry, Wilton, CT (US)

(73) Assignee: Melissa and Doug LLC, Wilton, CT (US)

(21) Appl. No.: 16/268,435

(22) Filed: Feb. 5, 2019

(51) Int. Cl. A63H 33/04; A63H 33/10; A63H 33/26; G09B 1/38; A63F 9/34

(52) U.S. Cl. CPC A63H 33/046; A63H 33/10; A63F 9/34; G09B 1/38; A63H 33/26

(57) ABSTRACT

A building toy is provided that includes panels that connect magnetically at their edges, or to a base structure, to construct scenes, structures, and vehicles, or combinations thereof, along with related accessories.

### BACKGROUND OF THE INVENTION

### 1. Field of the Invention

Devices, systems, and methods consistent with the invention relate to a building toy, in particular a toy that includes panels that connect magnetically at their edges, or to a base structure, to construct scenes, structures, and vehicles, or combinations thereof, along with related accessories.

### 2. Description of the Related Art

Building toys have long provided children with educationally enriching play. Through the act of building, kids develop foundational science, technology, engineering and math (STEM) skills such as spatial reasoning and decision making. Magnetic building toys such as Magformers®, Tegu®, and Magna-Tiles® have made building more accessible to children by having pieces that join magnetically without the need for precise dexterity that is often required when assembling with plastic building bricks such as Lego) or even plain wooden blocks that can easily topple. These existing magnetic building toys are composed of abstract plastic or wood shapes (panels) that can be combined magnetically to form a larger structure.

Build & Imagine's U.S. Pat. No. 9,713,777 discloses a magnetic construction toy that greatly improves on the prior art by providing illustrated, thematic backdrops for imaginative play and magnetic panels that may be assembled and re-assembled with ease and without small pieces that could present a choking hazard to small children.

The magnetic panels disclosed by U.S. Pat. No. 9,713,777 do however, suffer from manufacturing and performance problems. Additionally, there is a need for further improvements to the system to enhance the play value, such as by adding base structures upon which the panels can be mounted, new panel types and constructions, new combinations of elements, and further accessories.

### BRIEF SUMMARY OF THE INVENTION

Construction toys are disclosed herein that encourage building and imaginative play via panels that connect magnetically to form a larger scene, structure or vehicle. The panels connect regardless of orientation, providing the child with freedom of choice to combine the panels in any way they choose. The magnetic connections are facilitated by magnets housed within the edge(s) of each panel, so that no separate small magnet connectors are required. The panels can be used with other base structures and with various accessories. These items and the freedom of configuration of the panels increase replayability as children experiment with different designs, providing endless opportunities for imaginative play.

In an embodiment, a construction toy has a first panel capable of magnetically connecting to a second panel, where the first panel includes: a first plate including a face side having an outer peripheral edge portion, a core side having an outer peripheral flange, and at least three edges: a second plate including a face side having an outer peripheral edge portion, a core side, and at least three edges; a first U-shaped edge portion including an outer surface and a core side, the first U-shaped edge portion extending along and shaped to interface on the core side with a first one of the at least three edges of the first and second plates, the first U-shaped edge portion comprising a first magnetic pocket having a volume defined at least partially by the core side and said outer peripheral flange of said first plate; at least one magnet arranged in the first magnetic pocket of the first U-shaped portions; and wherein the first U-shaped edge portion includes a first distal end that extends along, abuts, and at least partially covers a first one of the outer peripheral edge portions of the top plate, and a second distal end that extends along, abuts, and at least partially covers a first one of the outer peripheral edge portion of the bottom plate.

In another embodiment of the construction toy, the first distal end of the first U-shaped edge portion is ultrasonically welded to the outer peripheral edge portion of the top plate in a plane parallel to the face side of the first plate and the second distal end of the first U-shaped edge portion is ultrasonically welded to the outer peripheral edge portion of the top plate in a plane parallel to the face side of the second plate. In another embodiment of the construction toy, the core side of the second plate comprises an outer peripheral flange; an outer face of the outer peripheral flange of the second plate is in contact with an inner face of the outer peripheral flange of the first plate in a plane perpendicular to the face side of the first plate and the face side of the second plate. In another embodiment of the construction toy, the core side of first U-shaped portion comprises a first female connector; and an outer face of the outer peripheral flange of the first plate comprises a first male connector inserted into the first female connector on the first U-shaped portion. In another embodiment of the construction toy, a second U-shaped edge portion is provided, where the core side of first U-shaped portion comprises a first male interlock element, a core side of the second U-shaped portion comprises a first female interlock element, and the first male interlock element is inserted into the first female interlock element. In another embodiment of the construction toy, an outer face of the outer peripheral flange comprises a rib that at least partially defines said first magnetic pocket; and the magnet is permanently affixed to the rib.

In some embodiments, panels may be connected at their magnetic edges to form a three-dimensional scene, structure or vehicle. Faces of the panels may be unadorned, illustrated, connective, or decoratable. Panels may be connected at their magnetic edges such that illustrations, decorations, or connected features on adjacent faces form a contiguous illustrated scene or portion of a structure or vehicle. Panels may also be rearranged in sequence and/or converted to different orientations to create a multitude of different scenes or portions of a structure or vehicle. This freedom of configuration increases replayability as users modify a story context and experiment with different designs, providing endless opportunities for imaginative play. In some embodiments, panels have openings with one or more doors or play elements to enhance play. In some embodiments, a base structure is used in conjunction with panels to form a scene, structure, or vehicle.

In some embodiments, at least one accessory item is provided that is capable of attachment to or use with at least one face of at least one panel. In various embodiments, an accessory item may attach or adhere to the face of panel by magnetic attraction, adhesion, static electricity, or mechanical attachment. In various embodiments, an accessory may include a human or animal figure, furniture, clothing food, a tool, an appliance, a bag, a container, a scenery embellishment, a vehicle, a light fixture, or a weapon. Accessories may also be used together. Accessories may be used with the panels to further customize and embellish the scenes, structures, or vehicles. In some embodiments, accessories may be used on their own.

In an embodiment, a construction toy has a first panel capable of magnetically connecting to a second panel, and the first panel has a first face side having an outer peripheral edge portion, a second face side having an outer peripheral edge portion, at least one magnet arranged between the outer peripheral edge portions of the first and second face side, an opening extending between the first and second face sides, a first retention member arranged along the perimeter of the opening, a first door in said opening, connected to said first retention member on a first side of the opening, and a second door in said opening, connected to said first retention member on a second side of the opening. In another embodiment, the first door is shaped as an awning and the second door is shaped as a counter.

In an embodiment, a construction toy has a first panel capable of magnetically connecting to a second panel, and the first panel has a first face side having an outer peripheral edge portion, a second face side having an outer peripheral edge portion, at least one magnet arranged between the outer peripheral edge portions of the first and second face side, an opening extending between the first and second face sides, a first retention member arranged along the perimeter of the opening, and a first additional play element in the opening, connected to said first retention member on a first side of the opening so as to be articulatable in at least one direction, where the first additional play element is representative of any attachment that can normally be found on a vehicle.

In an embodiment, a construction toy includes a vehicle and at least one panel capable of being magnetically connected to another panel along its edge, where the vehicle further provides retention features in which the edge of the at least one panel may be retained to form a structural feature of the vehicle. In another embodiment, the construction toy includes at least two panels capable of being magnetically connected along their edges, where the vehicle is a truck and the two panels form at least one side and a roof of the truck. In another embodiment, the construction toy includes at least two panels capable of being magnetically connected along their edges, where the vehicle is a ship and the two panels form sails. In another embodiment, the construction toy includes a crows nest having a second set of retention features connectable to the two panels.

The above stated aspect, as well as other aspects, features and advantages of the invention will become clear to those skilled in the art upon review of the following description. It should be understood that the description and specific examples, while describing several exemplary embodiments, are intended for purposes of illustration only and are not intended to limit the scope of the disclosure.

### BRIEF DESCRIPTION OF THE DRAWINGS

The above and/or other aspects of the invention will be more apparent by describing in detail exemplary embodiments of the invention with reference to the accompanying drawings, in which:

FIGS. 1(A)-(C) depicts exemplary embodiments of panels as described herein.

FIG. 2 depicts an exemplary embodiment of a scene construed using panels as described herein.

FIGS. 3(A) and (B) depict exemplary embodiments of a structure construed using panels as described herein.

FIG. 4 depicts an exemplary embodiment of a vehicle construed using panels as described herein.

FIG. 5(A) though 5(T) depict an exemplary embodiment of a composite vehicle constructed using a base structure and panels as described herein. FIGS. 5(A), 5(C), 5(E), 5(G), 5(I), 5(M), 5(Q), and 5(S) depict different views of the vehicle with panels installed. FIGS. 5(B), 5(D), 5(F), 5(H), 5(J), 5(N), 5(R), and 5(T) depict different views of the vehicle with panels not installed. FIGS. 5(O) and 5(P) show views of the crows nest.

FIG. 6 depicts a plan view of an exemplary embodiment of panels connected magnetically at edges as described herein.

FIGS. 7(A) through 7(C) depict exemplary embodiments of panel edges. FIG. 7(A) depicts a panel edge in isolation. FIG. 7(B) shows panels meeting at a 90 degree angle. FIG. 7(C) shows panels assembled in a T-shaped configuration.

FIG. 7(D) depicts an exemplary embodiment of panels in a face to face configuration.

FIG. 8 depicts an exemplary embodiment of panels in a face to face configuration.

FIG. 9 depicts an exploded view of an exemplary embodiment of a panel construction.

FIG. 10(A) depicts an exploded perspective view of an exemplary embodiment of a panel construction.

FIG. 10(B) depicts an exploded perspective view of an exemplary embodiment of a panel construction.

FIG. 11 depicts an exemplary embodiment of a pin and post connection securing plates of a panel.

FIGS. 12(A)-(D) depicts an exemplary embodiment of connections for U-shaped edge pieces and plates of a panel.

FIG. 13 depicts a cross section of an exemplary embodiment of the interface between U-shaped edge pieces and plates of a panel.

FIGS. 14(A) and 14 (B) depict cross sections of exemplary embodiments of the interface between U-shaped edge pieces, a magnet, and plates of a panel.

FIG. 15 depicts a cross section of an exemplary embodiment of the interface between U-shaped edge pieces, labels, and plates of a panel.

FIGS. 16(A) and 16(B) depict an exemplary embodiment of a cylindrical magnet usable with the panels.

FIGS. 17(A) and (B) depict exemplary embodiments of rotatable magnets usable with the panels.

FIG. 18(A)-(C) depict a composite magnet assembly usable with the panels.

FIG. 19 depict a spherical magnet usable with the panels.

FIG. 20 depicts a dual pole block magnet usable with the panels.

FIG. 21 depicts a perspective view, partly in section, of an exemplary embodiment of a panel, showing arrangement of dual pole magnets.

FIG. 22 depicts a multipole block magnet usable with the panels.

FIG. 23 depicts a perspective view, partly in section, of an exemplary embodiment of a panel, showing the arrangement of a four-pole multipole magnet.

FIG. 24(A)-(F) depict exemplary embodiments of accessory items as described herein. FIG. 24(A) shows an exemplary illustrated panel without accessory items. FIG. 24(B) shows exemplary accessory items which may be used to embellish the scene depicted on the panel. FIG. 24(C) shows exemplary accessory items added to the scene on the panel. FIGS. 24(D) and 24(E) depict an exemplary embodiment of a doll with a base. FIG. 24(F) depicts a stand usable with a doll.

FIGS. 25(A) and 25(B) depict exemplary embodiments of accessory items and different characters.

FIG. 26 depicts exemplary embodiments of panels with openings and doors.

FIGS. 27(A)-(C) depict an exemplary embodiment of a door construction and attachment scheme in the opening of a panel.

FIG. 28 depicts an exemplary embodiment of a panel with an opening and two doors.

FIG. 29 depicts an exemplary embodiment of a panel with an additional play element.

FIGS. 30(A) through 30(L) depict an exemplary embodiment of a vehicle in the form of a submersible. FIGS. 30(A), 30(B), and 30(E) through 30(J) depict the vehicle in various views in assembled form. FIGS. 30(C) and 30(D) depict the vehicle in exploded perspective views. FIG. 30(K) depicts the vehicle in perspective view with a doll inserted therein and without the top cover. FIG. 30(LP depicts the vehicle in perspective view with no doll or top cover.

FIGS. 31(A) through 31(L) depict an exemplary embodiment of a vehicle in the form of a car. FIGS. 31(A), 31(B), 31(F), and 31(H) through 31(L) depict the vehicle in various views. FIGS. 31(C), 31(E), and 31(G) depict the vehicle in various views with a doll inserted therein. FIG. 31(D) depicts a cross section of the vehicle with dolls inserted.

FIG. 32(A) through 32(I) depict an exemplary embodiment of a vehicle in the form of a work truck in various views.

FIG. 32(J) through 32(P) depict a second exemplary embodiment of a vehicle in the form of a work truck in various views. FIG. 32(Q) is a cross section on line Q in FIG. 32(O) to show detail.

FIG. 33(A)-(D) depict a third exemplary embodiment of a vehicle in the form of a work truck.

FIG. 34 depicts an exemplary embodiment of a vehicle in the form of a food truck.

FIG. 35(A) through 35(J) depict an exemplary embodiment of a vehicle in the form of a fire truck in various views.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

Building toys and methods of use for constructing scenes, structures, and vehicles, are provided. The building toys disclosed herein include, as their basic structure, panels of varying shapes and sizes that connect at their edges via magnetic attraction. The panels may have unadorned, connective, illustrated, or decoratable surfaces, in whole, in part, or in combination. The panels may be connected to each other, or to a base structure, to create a scene, a structure, a vehicle, or a combination thereof. Further accessories may be provided.

### Panels

The basic component of the building toys described herein is a panel. Each panel contains at least two faces, typically parallel or substantially parallel to each other, and at least three edges. The faces are in the form of polygon shapes, such as triangles, squares, rectangles, pentagons, etc., and may be of varying sizes. Each panel contains two faces of the same polygon shape and of the same or substantially the same dimensions, and each side of the polygon forms an edge of the panel (e.g., three edges for a triangular panel, four edges for a square or rectangular panel, etc.). The edges are perpendicular or substantially perpendicular to the faces. Each edge has a depth suitable to contain one or more embedded magnet(s), as described herein.

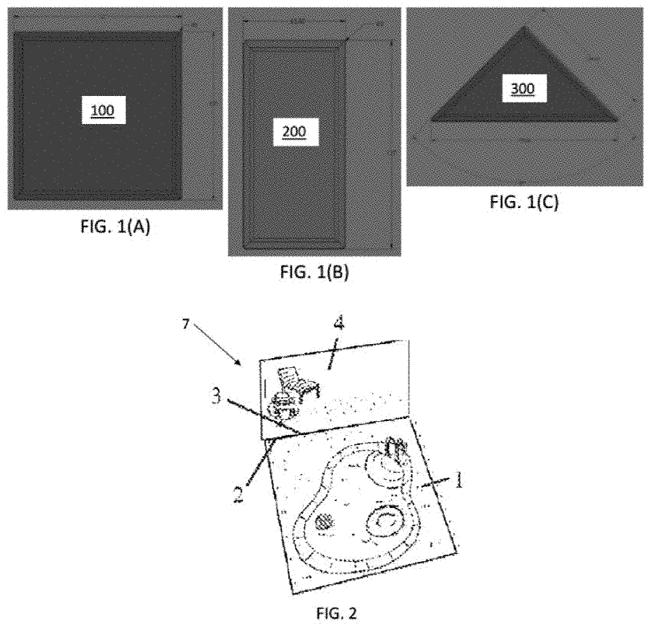

Exemplary panels are shown in FIGS. 1(A)-1(C), which show square panel 100, rectangular panel 200, and triangular panel 300, respectively. As mentioned above, however, panels may be of any polygon shape and any appropriate dimension. Appropriate dimensions include those appropriate for use by the age range of children or other individuals who will be using the panels. For example, panel dimensions may be suitable to allow a user (e.g., a child) to pick panels up and manipulate them with their hands. Non-limiting exemplary dimensions are shown in FIGS. 1(A)-(C).

A panel may be connected to one or more other panels to form a scene. Non-limiting examples of scenes are scenic backdrops, maps, playing surfaces, or gameboards. A panel may also be connected to one or more other panels to form a structure. Non-limiting examples of structures are houses, buildings, or enclosures. A panel may also be connected to one or more other panels to form a vehicle. Non-limiting examples of vehicles are cars, trucks, planes, or ships. A panel or panels may also be connected to a base structure representing portions of a scene (e.g., a hill or holder), a structure (e.g., a building foundation), or a vehicle (e.g., a truck frame or ship hull) to form a composite scene, vehicle, or structure. As used herein, a plurality of panels refers to two or more panels and typically refers to a number of panels that is sufficient for the user to construct a scene, structure, or vehicle for imaginative play.

A panel's opposing faces may be unadorned for simple play, or may have various interactive features as described in the following exemplary embodiments.

In an exemplary embodiment, one or more of the panel faces may be illustrated. Non-limiting examples of illustrations are rural, urban, or natural exterior scenes, an interior or exterior floor, wall, or roof of a building or other structure, or the body, hull, or structural or mechanical features of a vehicle. The illustration itself can be in any suitable form. Non-limiting examples include drawings, sketches, paintings, photographs, engravings, etchings, or embossings, of things seen, remembered, or imagined, using a graphic or tactile representation, or combinations of such elements.

In another exemplary embodiment, one or more of the panel faces may be decoratable, which means that the panel face surface allows a user to decorate the panel face using their own imagination and creativity. Non-limiting examples of decoratable faces include dry erase surfaces, chalkboard surfaces, or fixed or removable/replaceable paper, cardboard, or canvas features, or combinations of such elements.

In another exemplary embodiment, one or more of the panel faces may be connective, to allow a user to add accessory elements, such as decorations, people, animals, or other details, to the face. Examples of connective faces include magnetic surfaces, magnetically receptive surfaces, mechanically connectable surfaces (e.g., Velcro®), surfaces that support adhesion by static electricity, and adhesive surfaces.

Portions of individual panel faces may be entirely unadorned, illustrated, decoratable, or connective. Alternatively, individual panel faces may have two or more separate sections of an unadorned, illustrated, decoratable, or connective configuration. The same panel face or panel face section may also include two or more interactive features. For example, a panel face may be illustrated and connective, or illustrated and decoratable, or decoratable and connective, or any appropriate combination of the features described herein. Opposite panel faces may include the same face provisions (e.g., two illustrated faces) or different face provisions (e.g., one decoratable and one illustrated face), in whole or in part.

Each panel contains one or more magnetic edges. A magnetic edge refers to an edge of a panel that contains at least one magnet embedded within the panel and in proximity to the edge, and configured to magnetically attract a magnetic edge of another panel. One, some, or all of the edges of a panel may be a magnetic edge. Panels may be connected by magnetic attraction between their respective magnetic edges to construct the scenes, structures, or vehicles discussed herein. In some embodiments, panels are connected in a parallel manner (180° angle). In other embodiments, panels are connected in a perpendicular manner (90° angle). In other embodiments, panels are connected at acute or obtuse angles. Scenes, structures, and vehicles built by magnetically connecting panels may include any one or more of these parallel, perpendicular, acute, or obtuse connections, or any other geometric connection afforded by the panel configurations.

In some exemplary embodiments, panels may be connected magnetically at adjacent edges to form a scene, such as a contiguous rural scene, cityscape, or natural landscape. Or the panels may be connected to form a more interactive scene, such as a map, playing surface (e.g., a playground or soccer field), or gameboard.

An example of a scene 7 is shown in FIG. 2, which depicts a square panel 1 with an illustrated face and rectangular panel 4 with an illustrated face connected at magnetic edges 2 and 3, respectively. Together, the panels portray a pool scene. Square panel 1 is arranged horizontally and has on its illustrated face a pool. Rectangular panel 4 is arranged vertically and has on its illustrated face with a pool deck scene. Together, the illustrated faces of panels 1, 4 provide a contiguous scene.

Scenes may be made by following instructions (e.g., instructions may be provided to the user to show how to form a particular scene by arranging panels in a particular manner) or may be user-defined. Scenes may also be connected to vehicles or structures, or other scenes.

In some exemplary embodiments, panels may be connected magnetically at their magnetic edges to form a three dimensional structure, such as a house, building, or other enclosure. In such an arrangement the panels may form, for example, interior and/or exterior walls, floors, ceilings, or roofs.

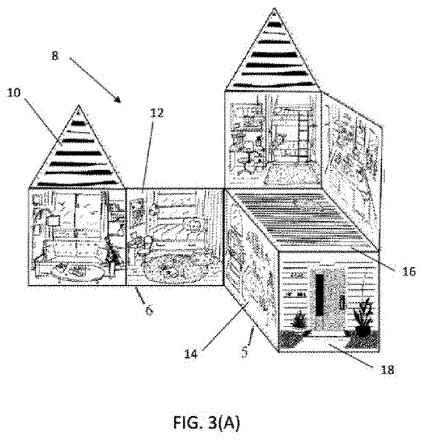

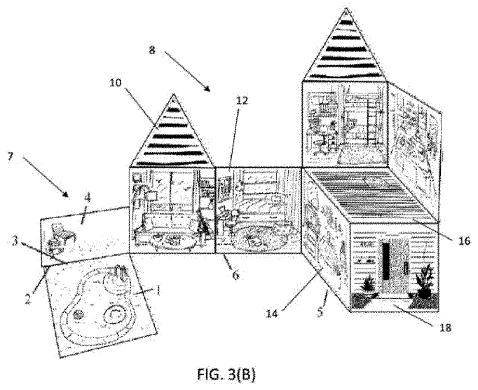

An example of a structure 8 is shown in FIG. 3, which depicts a number of panels with illustrated faces connected at magnetic edges that together form a building with walls, floors, and a roof. In this exemplary embodiment, some square panels, such as square panel 12, are arranged vertically and have an illustrated face depicting a home interior. Another square panel 18 is arranged vertically and has an illustrated face depicting a home exterior. A rectangular panel 14 is arranged vertically and has an illustrated face depicting a home interior. A rectangular panel 16 is arranged horizontally and has an illustrated face depicting wood flooring. And triangular panels, such as triangular panel 10 are arranged vertically or at an angle and has an illustrated face depicting roof shingles. Together, the illustrated faces of these panels provide a depiction of a home interior and exterior with which a user may interact.

Structures may be made by following instructions (e.g., instructions may be provided to the user to show how to form a particular structure by arranging panels in a particular manner) or may be user-defined. Scenes or vehicles, or other structures, may also be connected to the structure. For example, the scene 7 of FIG. 2 may be connected to the structure 8 of FIG. 3(A), as shown in FIG. 3(B).

In some exemplary embodiments, panels may be connected magnetically at their magnetic edges to form a three dimensional vehicle, such as a car, truck, ship, submarine, construction equipment, etc, with the panels forming various vehicle exterior and interior surfaces or components.

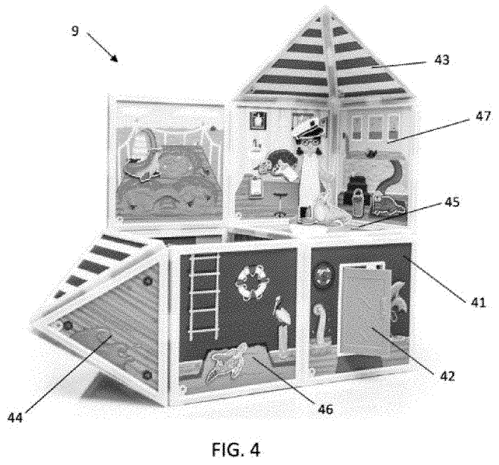

An example of a vehicle 9 is shown in FIG. 4, which depicts a number of panels with illustrated faces connected at magnetic edges. Together, the panels form a ship with a hull, deck, and superstructure.

In this exemplary embodiment, square panels, such as panels 41 and 46, may be connected to form the ship's hull. Square panel 45 may be arranged horizontally to provide the ship's deck. Square panels, such as panel 47, may be arranged vertically to form the walls of the ship's superstructure. Triangular panels, such as panel 43, may be arranged to form the roof of the ship's superstructure. And triangular panels, such as panel 44, may be arranged to form the ship's bow structure. In this embodiment, the triangular panels are arranged at angles to the adjacent square panels to form the roof and bow structures described above. The panels in this exemplary embodiment have various illustrated faces. In the arrangement shown in FIG. 4, panels 41, 46, and 47 depict interior scenes of the ship, panel 44 depicts an outer surface of the ship (e.g., the hull or deck), and panel 43 depicts a striped surface suitable for many applications. Together, the illustrated faces of these panels provide a depiction of a ship's interior and exterior with which a user may interact.

Vehicles may be made by following instructions (e.g., instructions may be provided to the user to show how to form a particular vehicle by arranging panels in a particular manner) or may be user-defined. Vehicles may also be connected to scenes or structures, or other vehicles.

Panels with one or more unadorned, connective, decoratable, or illustrated faces or face portions, or any combination thereof, may be used to form scenes, structures, or vehicles. And any of the scenes, structures, or vehicles may be connected to each other to provide a combined interactive set.

In any scene, structure, or vehicle made by connecting panels, such as are shown herein, where panels with illustrated faces or face portions are used, the illustrations may be designed such that panels may be rearranged in sequence and/or orientation to form different scenes, structures, or vehicles from the same set of panels. And the illustrated faces of panels are not intended to limit the creation of scenes, structures, or vehicles to a particular arrangement or orientation. A user may arrange panels in any configuration, with the content of the particular illustrated faces consistent or inconsistent, or continuous or discontinuous, with a particular scene, structure, or vehicle.

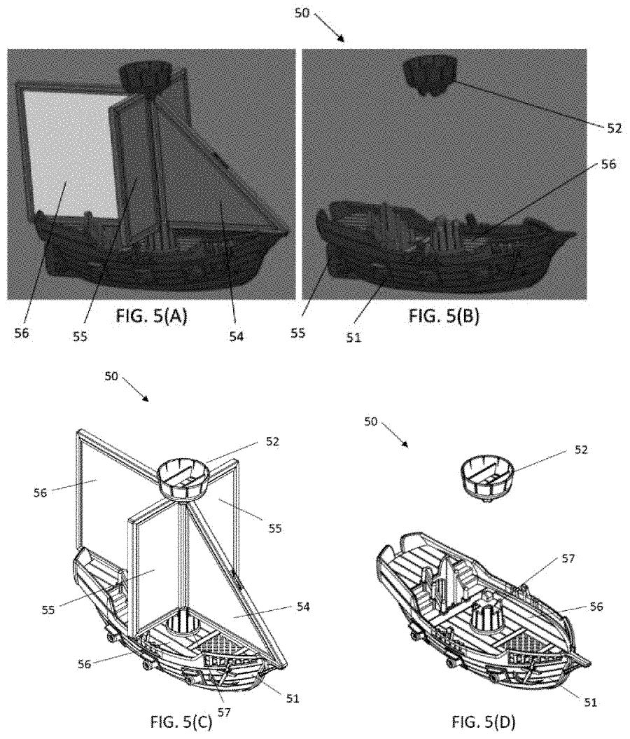

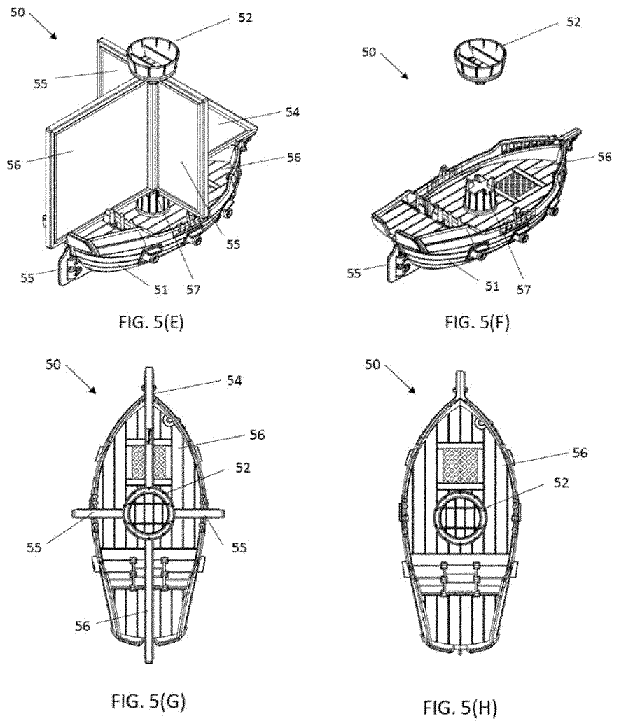

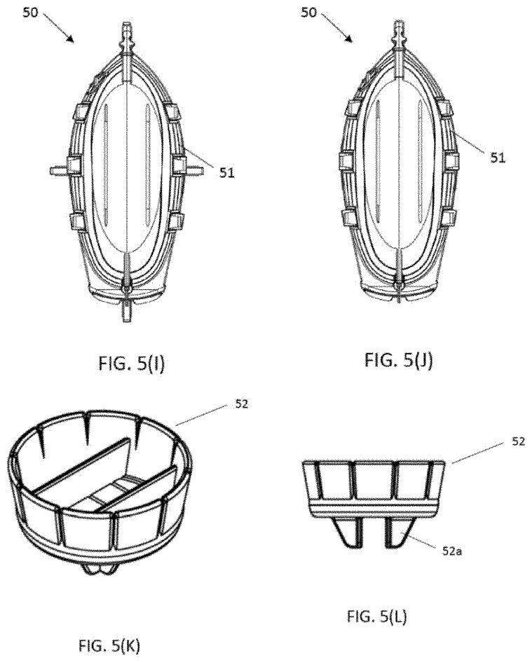

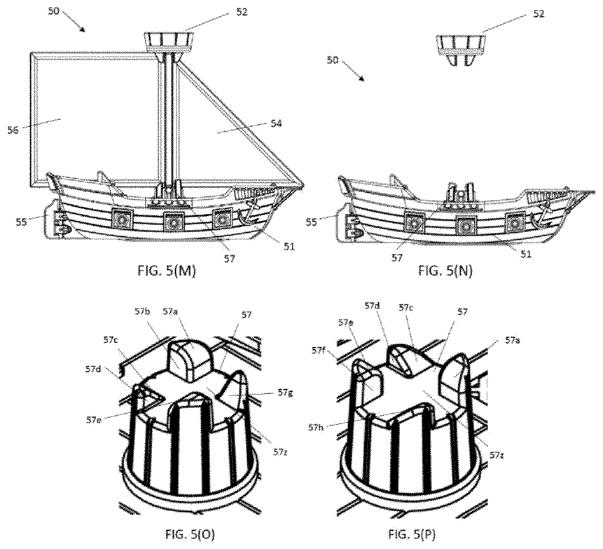

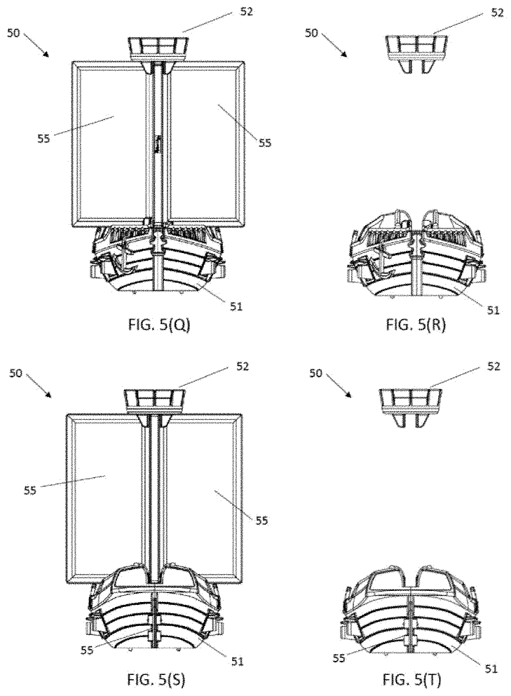

In some embodiments, scenes, structures, or vehicles may be formed by panels connected magnetically at their magnetic edges to other panels and/or to a base structure. An exemplary embodiment of such a configuration is shown in FIGS. 5(A)-(T).

In the embodiment shown in FIGS. 5(A)-5(T), a base structure 50 including a ship hull 51 and crow's nest 52 is provided with features that allow an interface with panels 54, 55, and 56 to thereby form a complete ship. In this embodiment, the sails of the ship are made by magnetically connected panels, including a square panel 56 for the rear sail, two rectangular panels 55 for the side sails, and one triangular panel 54 for the front sail. Panels with one or more faces having unadorned, connective, decoratable, or illustrated faces, or any combination thereof, may be used for the sails. The panels may be connected to the base structure using magnetic features, an interference fit, or any suitable connection method. If a magnetic connection is utilized, the base structure may include any type of suitable magnet or other features that provide a magnetic connection, such as small metal plates.

In one embodiment, four panels 54, 55, 55, 56 may be connected along common edges to form the ship's sails, as shown in FIGS. 5(A), 5(C), 5(E), 5(G), 5(M), 5(Q), and 5(S). At one end, the connected panels 54, 55, 55, 56 may rest on mast base 57 with tabs to assist in the location and retention of panels 54, 55, 55, 56. In one embodiment, the retention tabs may have the features illustrated in, for example, FIGS. 5(O) and 5(P), where mast base 57 has tabs with vertical surfaces (e.g., vertical surfaces 57d, 57f, 57b) and beveled surfaces (e.g., beveled surfaces 57e, 57c, 57a, 57g). Tabs shaped in this manner assist in both retention and insertion of the panels 54, 55, 55, 56. Tabs may also have all vertical walls. Crows nest 52 may also have retention tabs with vertical walls or the combination of vertical walls and beveled surfaces as shown on mast base 57.

Base structures can be formed in any suitable manner. For example, ship hull 51 may be made of two halves, a deck 56, a rudder 55, and crow's nest 52. The rudder 55 and deck 56 are retained between the right and left halves of hull 51 when they are connected. The halves of hull 51 may be held together in any suitable manner, such as by glue, fasteners, or ultrasonic welds, and may be located to each other by pins.

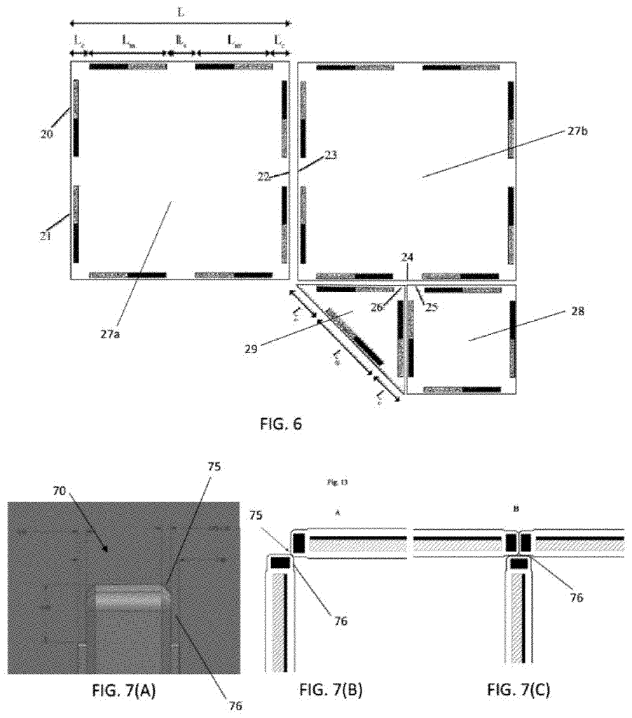

The panels described herein can be of various sizes and shapes, and scenes, structures, and vehicles can be formed of panels of one size or varying sizes. Examples of such connection strategies are illustrated in FIG. 6. In some embodiments, adjacent panels in a scene, structure, or vehicle have edges of the same length, such that they magnetically connect along the entire length of the adjacent magnetic edges. This type of connection is shown along edges 22 and 23 of panels 27a and 27b in FIG. 6. In some embodiments, adjacent panels in a scene, structure, or vehicle have edges of different lengths and the shorter magnetic edge of one panel (e.g., edges 25 or 26 of panels 28 or 29 in FIG. 6) magnetically connects along a portion of the length of the longer magnetic edge of the other panel (e.g., edge 24 of panel 27b in FIG. 6).

Edges of the panels may have configurations appropriate to allow the connections described herein, such as the perpendicular, parallel, acute, and obtuse connections described above that are used to form scenes, structures, or vehicles. For example, panel edges may have angled sections and chamfers to aid in retention, particularly when panels are arranged in a perpendicular fashion.

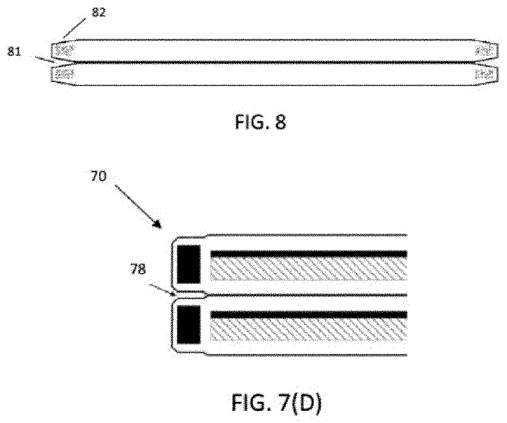

For example, as shown in FIGS. 7(A)-7(C), panel edges 70 may include angled sections 75 at their ends, which allow panels to connect at respective edges in the manner shown in FIG. 7(B). This edge design assists in minimizing the distance between magnets of adjacent panels during use and provides additional physical support for the panels, both reducing the distance and providing a physical resting point, with panels arranged at 90 degree angles meeting at an angle (FIG. 7(B), 45).

As a further example shown in FIGS. 7(A)-7(C), panel edges may have a step 76 created by chamfering the panel edge 70. The provision of step 76 allows improved vertical support when another panel is attached at a 900 angle, such as in the T-shaped configuration for constructions of a three-dimensional structure shown in FIG. 7(C).

Similarly, the angles and chamfers can provide additional lateral support when panels are arranged as two adjacent walls.

Sets of panels and related accessories and base structures may be provided in a box, bag, or any other suitable enclosure capable of holding and/or sorting these elements. Base structures may also include storage provisions for panels and accessories. The panels themselves may also be configured to provide their own storage configuration for the panels and accessories.

For example, panels may be stored or carried in a sandwiched configuration, with faces parallel or substantially parallel to each other and bound together by magnetic attraction at the magnetic edges. Depending on the configuration, when sandwiched, the magnetic attraction between panels may make it challenging to pull the panels apart to initiate play, particularly for small children or individuals impaired in certain motor skills.

In some embodiments, a spacing is provided in the form of a ridge or gap between panels, which facilitates pulling sandwiched panels apart. Spacings may be configured to provide finger hold leverage and/or to reduce panel-to-panel magnetic attraction when panels are sandwiched face-to-face, by increasing the distance between the edge magnets. In some embodiments, spacings are configured such that magnetic attraction between sandwiched panels is reduced to a degree sufficient to facilitate pulling the panels apart, while preserving sufficient magnetic attraction between panel edges for use as a construction toy as described herein, e.g., sufficient attraction between magnetic edges to hold a three dimensional structure and/or scenery backdrop together.

In some exemplary embodiments, at least a portion of a panel edge may be beveled 82, as shown in FIG. 8, to provide a gap 81. The provision of gap 81 allows insertion of a finger between panel edges and/or decreases magnetic attraction between magnets in adjacent magnetic edges in the stack of panels, to facilitate pulling the panels apart.

In other exemplary embodiments, panels may contain at least one recessed area or ridge on at least a portion of at least one edge and/or on at least a portion of at least one face.

The angled and chamfered ends described above may also provide similar functionality, where these features provide a gap 78 along the edges 70 of the panels when they are stacked face to face, as shown in FIG. 7(D).

In any of these nonlimiting examples, a gap or space is created between adjacent panels in a stack, making it easier to pull the stacked panels apart by providing a finger hold, reducing the magnetic attraction between panels by increasing the distance between adjacent magnets, or both. Combinations of these examples may also be used as appropriate. Each of these examples, or other similar features, may also be used along with the other edge design elements discussed herein.

In some embodiments, a carrier may be provided for ease of carrying panels that are stacked or otherwise connected together. For example, a carrier may contain magnetic or magnetically receptive material at one end, which may attach by magnetic attraction to one or more edge(s) or face(s) of one or more panel(s) to allow easy carrying of one or more panels. A carrier may also include provisions to contain and carry accessories or base structures. A carrier may be made of any suitable material that is capable of supporting the weight of a desired stack or other arrangement of panels. For example, materials that may be suitable for construction of a handle include, but are not limited to, ribbon, cloth, rope, fabric, leather, plastic, wood, or metal chain.

In another embodiment, a carrier may also attach to a panel edge using any suitable mechanical attachment method, including hooks and loops, snaps, etc. In another embodiment, a carrier may also be provided as part of a panel. For example, the carrier may be an extendable portion of the edge of a panel that can be released and extended by mechanical action.

### Panel Faces

As described above, panels may have unadorned, connective, decoratable, or illustrated faces, in whole or in part.

An unadorned panel face is simply that; it has no interactive features. In one exemplary embodiment, it is formed of whatever material the remainder of the panel is formed of. In other embodiments, it may be formed of any suitable material.

A connective face may be provided in a number of ways, but generally contains a material on at least a portion of its exterior surface, or interior to at least a portion of the face of the panel, that is configured to connect one or more elements, such as accessory item(s), to the exterior surface of the panel. This allows a user to add accessory items, such as decorations, people, animals, or other details to the connective face.

In some embodiments, a connective face (or face portion) may contain an interior or exterior magnetically receptive material, which may attract a magnetic portion of an accessory item. In other embodiments, a connective face (or face portion) may contain an interior or exterior magnetic material, which may attract a magnetically receptive portion of an accessory item. In other embodiments, a connective face (or face portion) may contain both magnetic and magnetically receptive materials in different interior and/or exterior areas of the panel face. Magnetic receptive material refers to a material that attracts a magnetic material but is not itself permanently magnetic. Magnetic receptive material may include, but is not limited to, rolled steel, a steel plate or grid, a flexible magnetic roll product, such as FlexIron™, FlexMag™ or RubberSteel®, or a magnetic paint.

In one embodiment, at least a portion of the exterior surface of a panel face includes a magnetic receptive material. In another embodiment, at least a portion of the exterior surface of a panel face includes a magnetic material. In a further embodiment, at least a portion of the exterior surface of a panel face includes a magnetic receptive material and at least a portion of the exterior surface of the face also includes a magnetic material. In a still further embodiment, the exterior surface of the panel face is constructed of a material that is not magnetic or magnetic receptive, and magnetic and/or magnetic receptive material(s) are interior to the panel face but configured such that they are capable of magnetically attracting magnetic receptive and/or magnetic materials, respectively, to the exterior surface of the panel face.

In some embodiments, a connective face (or face portion) may include a mechanically connectable surface (e.g., Velcro, snaps, hooks, etc.), which may mechanically connect to a compatible mechanical connection of an accessory item. In other embodiments, a connective face (or face portion) may include suitable constructions that allow adhesion of compatible accessories by static electricity. In other embodiments, a connective face (or face portion) may include an adhesive surface that allows adhesion of compatible accessories. In each of these non-magnetic connective faces, the connective structure may be arranged on the panel face by any known method, such as by adhesive or integrally molding the structure on the panel face.

An illustrated panel face may also be provided in a number of ways. An illustrated panel face (or face portion) may be formed by directly printing, engraving, etching, or embossing a design on the exterior face of a panel in any suitable manner. Alternatively, an illustrated panel face (or face portion) may be provided by affixing an exterior sheet with printing, engraving, etching, or embossing on an unadorned panel face (or face portion) by any known manner, such as by adhesive.

In some embodiments, the exterior sheet(s) may be constructed of a printed sticker, printed cardstock, a vinyl layer printed onto magnetically receptive material, wood veneer with illustrations heat transferred, painted, etc. onto the surface, or other suitable materials known to those of skill in the art. The particular illustration on an illustrated panel face (or face portion) may be relevant to a particular scene, structure, or vehicle, or may be generic.

The properties of an illustrated panel face (or face portion) and connective panel face (or face portion) may also be easily combined in several ways to provide increased play opportunity. For example, the exterior illustrated sheet described above can itself be formed of a magnetic or a magnetically receptive material, or include magnetic or a magnetically receptive portions.

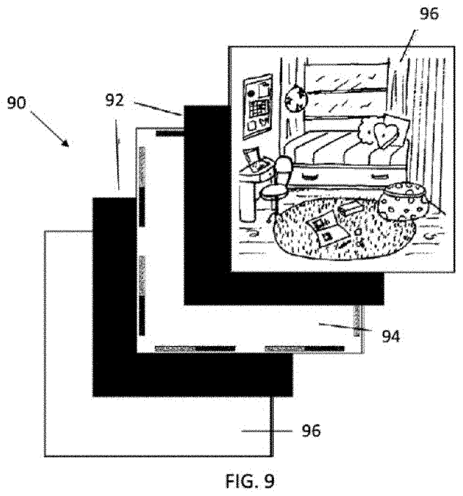

In the exemplary embodiment depicted in FIG. 9, a combined illustrated and connective panel 90 may be constructed with at least one magnetic receptive material (e.g., magnetic receptive sheet) 92 covering at least a portion of at least one panel face, or the entire face, and at least one exterior sheet 96 that covers the magnetic receptive material and includes an illustration on its exterior-facing surface. Such an arrangement allows, for example, magnetic attachment of accessories on the illustrated face.

A decoratable panel face (or face portion) may also be provided in a number of ways. For example, a decoratable panel face (or face portion) may be provided by affixing an exterior sheet that allows a user to decorate the panel face using their own imagination and creativity by any known manner, such as by adhesive.

Non-limiting examples of decoratable faces include dry erase surfaces, chalkboard surfaces, or fixed or removable/replaceable paper, cardboard, or canvas features, or combinations of such elements.

Similarly to the exemplary embodiment of FIG. 9, a combined decorative and connective panel face may also be constructed with at least one magnetic receptive material covering at least a portion of at least one panel face, or the entire face, and at least one exterior sheet that covers the magnetic receptive material and includes a decoratable surface (e.g., dry erase, chalkboard, paper, cardboard, canvas, or any other suitable alternative) on its exterior-facing surface. Such an arrangement allows magnetic attachment of accessories on the decoratable face.

As described above, panels may have unadorned, connective, decoratable, or illustrated faces, in whole or in part. Portions of individual panel faces may be entirely unadorned, illustrated, decoratable, or connective. Alternatively, individual panel faces may have two or more separate sections of an unadorned, illustrated, decoratable, or connective configuration. The same panel face or panel face section may also include two or more interactive features, such as the combinations of connective and illustrated or decoratable faces described above, or any appropriate combination. Opposite panel faces may include the same face provisions (e.g., two illustrated faces) or different face provisions (e.g., one decoratable and one illustrated face), in whole or in part, or any other appropriate combination.

### Panel Construction

The panel described herein may be made of any suitable material, and be constructed to provide the panel face and magnetic arrangements discussed herein. As a safety feature, the panel may be constructed such that magnets cannot be easily removed by a user.

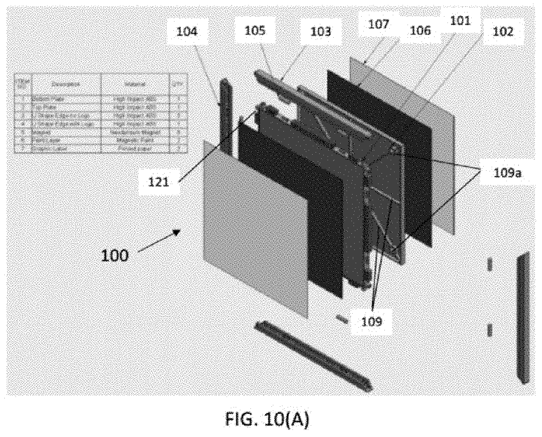

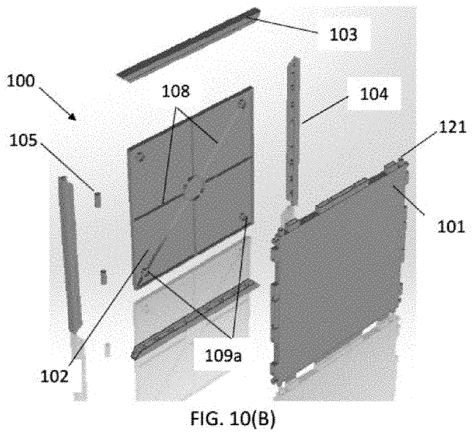

In one exemplary embodiment, a panel 100 is constructed as illustrated in FIGS. 10(A) and 10(B), including bottom plate 101, top plate 102, two U-shaped edges 103, two U-shaped edges 104, four magnets 105, connective layers 106, and labels 107 with illustrations. In the embodiments of FIGS. 10(A) and 10(B), magnets 105 are illustrated in cylindrical form, but any of the magnets described herein may be used with corresponding adaptation of interfacing surfaces.

Plates 101, 102 and U-shaped edges 103, 104 can be made of any suitable material that can provide structural support and retention of additional layers (if any) and magnets. In one embodiment, these elements are made of high impact ABS plastic. In other embodiments, these elements may be constructed of suitable plastic or wood, or combinations thereof. In one embodiment, these elements are constructed of injection molded plastic.

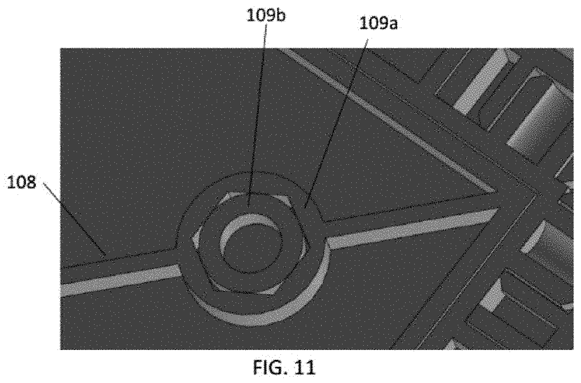

In this exemplary embodiment, plates 101, 102 are connected to each other by press fitting of a pin 109b and post 109a connection in each corner, as shown in FIGS. 10(A), 10(B), and 11.

In the illustrated embodiment, the pins 109b are round and the posts 109a are hexagonal, which provides improved retention. As can be seen in FIG. 11, which is a cross section of the pin 109b and post 109a connection, once pressed together, there is some space left between the pin 109b and post 109a. This allows the addition of glue therebetween to provide improved retention if required. This configuration allows for a looser manufacturing tolerances within the assembly. Either the pin 109b and post 109a can be provided on either plate 101 or plate 102.

In the illustrated embodiment, internal ribs 108 are provided on at least plate 102 for use as ultrasonic weld energy directors. Additional ultrasonic welding can provide further improved retention if required. Internal ribs also provide better rigidity for the assembled panel. Internal ribs 108 can be provided in either plate 102 or plate 101.

In these exemplary embodiments, the pin and post connections, glue, and ultrasonic welding, alone or in suitable combination, provide improved rigidity and stability for the panel as a whole, and make additional fasteners, such as screws, unnecessary.

As shown in FIGS. 10(A) and 10(B), the U-shaped edges 103 and 104 are provided along the edges of plates 101 and 102. U-shaped edges 103 and 104 have at least three functions. First, they retain magnets 105 between their internal structure and the edges of plates 101 and 102. Second, they fit around and provide an aesthetic cover for the edges of plates 101 and 102. Third, they provide improved rigidity, stability, and component retention for the panel as a whole.

In the exemplary embodiment of FIGS. 10(A), 10(B), and 11(A)-(D), U-shaped edges 103 and 104 have posts 123, 124 that connect to pins 121 arranged on plate 101. But the pin and post configuration can be reversed and be used with either plate 101 or plate 102, as appropriate.

In the illustrated embodiment, pins 121 are round and posts 124 are hexagonal, which provides at least the benefits discussed above (e.g, spacing for glue therebetween to provide improved retention, and looser manufacturing tolerances). As with the pin and post connection between plates 101, 102, glue and/or ultrasonic welding may also be used to provide enhanced retention of the U-shaped edges 103, 104 to plates 101.

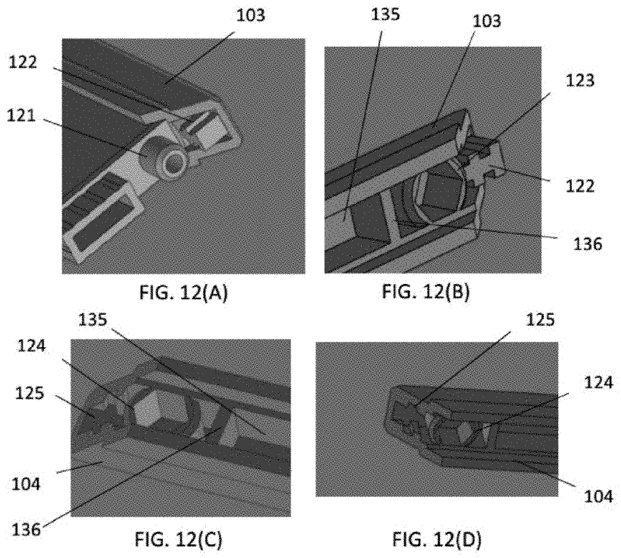

In one exemplary embodiment, U-shaped edges 103, 104 may also include interlock elements at each corner to provide enhanced strength and resistance to impact damage. In this embodiment, such interlock elements include male interlock element 122 on U-shaped edge 103 and female interlock element 125 on U-shaped edge 104, as illustrated in FIGS. 12(A)-12(D). These interlock elements are arranged to allow slidable engagement of U-shaped edge 103 to U-shaped edge 104 in the same motion where U-shaped edge 103 is connected to plate 101 via a pin 121 and post 123 connection. The male and female interlock elements may be provided on either U-shaped edge 103, 104.

Using the pin and post connections, glue, interlocks, and ultrasonic welding attachment methods discussed above, alone or in combination, provides significantly improved rigidity, stability, and component retention for the panel as a whole, and makes additional fasteners, such as screws, unnecessary. This provides manufacturing, durability, and safety improvements over the prior art.

Also illustrated in the exemplary embodiments of FIGS. 12(A)-12(D) are magnet pockets 135, for retention of magnets, and ribs 136, which define the longitudinal ends of magnet pockets 135. The magnet pockets may be of any configuration usable with the magnet alternatives discussed below. While FIGS. 10(A), 10(B), and 12(A)-(D) illustrate magnet pockets as being relatively large and ribs 136 as being relatively thin, their respective constructions may be varied to fit the magnets used.

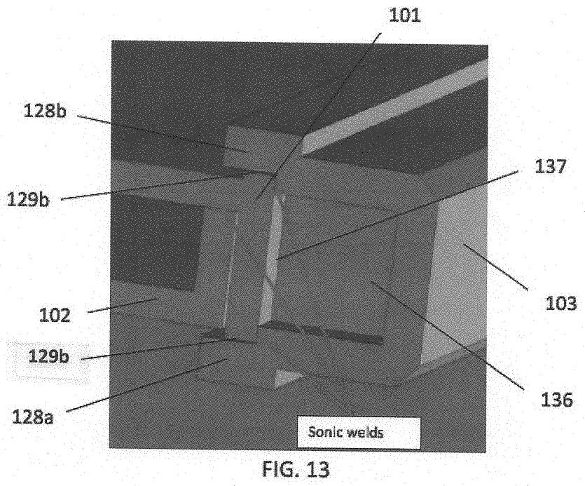

Cross sections of U-shaped edge 103 according to other exemplary embodiments of the invention are shown in FIGS. 13, 14, and 15. These cross sections, and the discussion below, are also applicable to U-shaped edge 104.

FIG. 13 shows a cross section through the longitudinal axis of U-shaped edge 103 along rib 136, although the features shown in this cross section are independent of the provision of rib 136. In FIG. 13, U-shaped edge 103 has distal extensions 128a, 128b that touch plate 101 along interfaces 129a, 129b. Interfaces 129a, 129b are then ultrasonically welded to provide additional connection robustness for the panel. These ultrasonic welds are in planes different from those of the ultrasonic welds between plates 101, 102 to enhance the rigidity, stability, and component retention for the panel as a whole, and is a drastic improvement on prior art designs. These connections may be provided along the extent of U-shaped edge 103.

FIG. 14(A) shows a cross section in the same direction as FIG. 13 through an exemplary magnet pocket 135 with an exemplary magnet 105. FIG. 14(A) shows similar features to FIG. 13, but instead of rib 136, this cross section shows magnet 105 in magnet pocket 136. In this embodiment, the magnet 105 is cylindrical and is axially retained by ribs 136 (not shown), but any suitable magnet design may be used, including any design discussed herein such as fixed rectangular magnets. In this embodiment, the magnet 105 is retained laterally by retention feature 142 and rib 141. Retention feature 142 in this embodiment is a depression in the inner portion of the top wall of U-shaped edge 103 that corresponds to the shape of magnet 105. Rib 141 extends from the surface of plate 101. These features retain cylindrical magnet 105 and allow it to rotate along its longitudinal axis during play (it is not glued in place), according to an exemplary embodiment using a cylindrical magnet.

In the embodiment of FIG. 14(A), the magnet 105 is retained laterally by retention feature 142 and rib 141. Retention feature 142 in this embodiment is a depression in the inner portion of the top wall of U-shaped edge 103 that corresponds to the shape of magnet 105. Rib 141 extends from the surface of plate 101. These features retain cylindrical magnet 105 and allow it to rotate along its longitudinal axis during play (it is not glued in place), according to an exemplary embodiment using a cylindrical magnet.

In other exemplary embodiments, multiple ribs, rather than a rib and depression combination, may be used for lateral retention of magnet 105. These ribs may extend from one or more of the plate 101 and U-shaped edge 103, and may extend in the longitudinal direction of magnet 105, like rib 141, or perpendicular to that direction.

Similar ribs and retention features could also be provided for any rotatable magnet shape disclosed herein. In some embodiments, where freely-movable magnets are used, rib 141 could be removed to provide a volume for magnet movement and alignment. In other embodiments, where fixed magnets are used, retention feature 142 could be removed and the magnet could be held in place by rib 141 only. Or fixed magnets could be retained using both ribs and retention features, or multiple ribs as discussed above. In other embodiments, any combination of the features discussed above could be utilized to provide magnet retention as necessary depending on the magnet type and design.

FIG. 14(B) depicts another embodiment where rectangular magnet 105′ is used. In this embodiment, magnet 105′ is retained laterally between retention feature 142 and rib 141 and axially by ribs 136 (not shown). Additional lateral retention may be provided by ribs extending from the inner surfaces of U-shaped edge 103 along the top and bottom surfaces of magnet 105′ in the orientation shown in FIG. 14(B). Magnet 105′ may also be retained by other measures, such as glue. Depressions such as retention feature 142 in FIG. 14(A) could also be provided to assist in the retention of magnet 105′, in a shape suitable to interface with magnet 105′. In one exemplary embodiment, as shown in FIG. 14(B), magnet 105′ is fit into magnet pocket 136 and is retained therein by rib 141. In addition, magnet 105′ is glued to rib 141, but not to the surfaces of the magnet pocket 136, which keeps magnet 105′ as close to the outside wall of U-shaped edge 103 as possible (and with fewer intervening layers) to provide maximum magnetic strength.

In the embodiments of FIG. 14(B), because magnet 105′ is held in place with adhesive on rib 136, the chances of it being retained in place in case of panel breakage is improved. This adds a safety factor to the design as a whole, particularly when small children are using the panel. The use of panel connection strategy discussed herein, including multiple mechanical connections (e.g., the pin and posts and interlock elements), glue, and ultrasonic welds, provides enhances rigidity, stability, and component retention for the panel as a whole, thus reducing the chances of panel breakage and internal components being released, which provides additional safety measures.

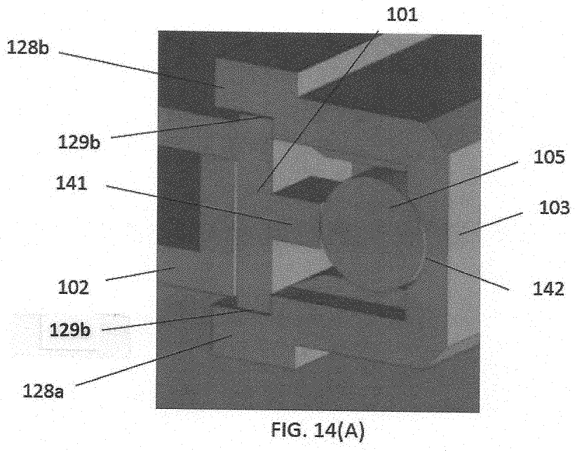

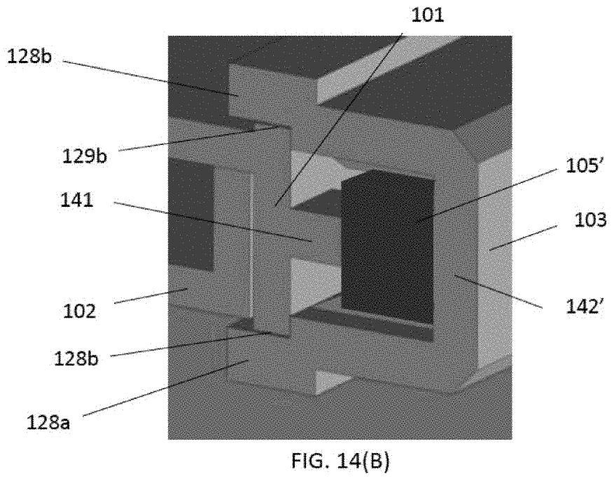

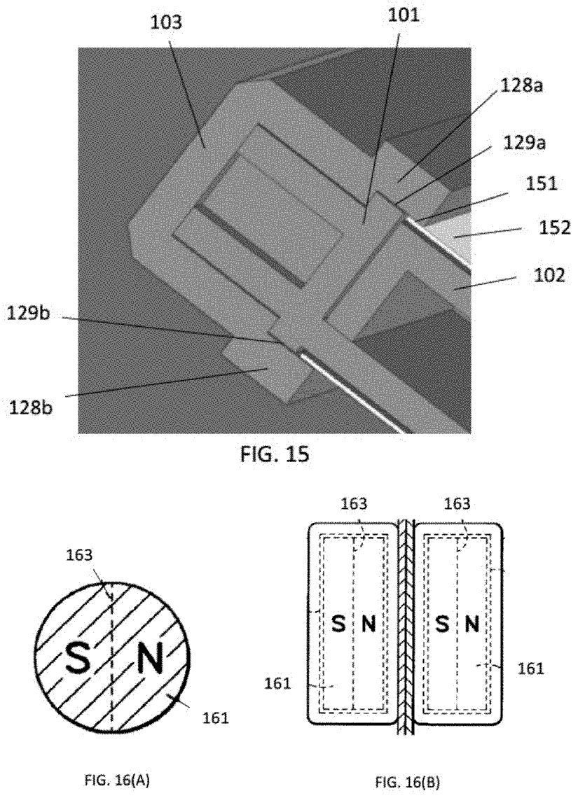

As shown in the exemplary embodiment of FIG. 15, distal extensions 128a, 128b of U-shaped edge 103 extend past the widest portion of the combination of plates 101, 102 to allow for permanently affixed illustration or decorative labels 152 to be arranged so that their lateral edges 151 fit under the distal extensions 128a, 128b of U-shaped edge 103. This arrangement hides the lateral edges 151 of the label 152, improves its retention on the panel face, and improves the overall appearance of the panel.

Although the above description is focused on the structure, number of parts, part design, material, and assembly method for square panels, it is equally applicable to other panel shapes, such as triangles and rectangles, with suitable dimensional and directional modification.

The above edge designs are also intended to provide radiused corners to avoid potential scratch and cut hazards during play.

### Magnets

The panels described herein contain at least one magnetic edge, where the magnetic edge includes at least one magnet embedded within proximity of the edge and oriented to magnetically attract a magnet embedded within proximity of the edge of another panel, such that the panel edges connect by magnetic attraction when they are brought into contact.

Typically, magnets are embedded at a depth within the panels that is at close proximity to a panel edge, such that magnetic panel edges will magnetically attract each other when they are brought into close contact. A suitable depth for magnets within the panel edge may be dependent on factors such as the strength of the magnets and the type of material in which they are embedded. For example, the magnets should be embedded at a depth such that when two panels are connected by magnetic attraction at their respective magnetic edges and held or suspended with panel faces in a vertical orientation and with the connected magnetic edges at an intermediate position between the top panel and the bottom panel, the bottom panel will remain magnetically attached to the top panel. In one embodiment, magnets are embedded at a depth of 1 mm from the panel edge.

As described above, various magnet sizes, strengths, and designs that provide the required connectivity may be used with the panels described herein, including the cylindrical magnets, other rotating magnets, spherical magnets, freely-movable magnets, or rectangular magnets.

In one exemplary embodiment, as shown in FIG. 16(A), cylindrical magnets are used with north N and south S poles arranged as opposite halves of the magnet 161 throughout its length, divided as by an imaginary plane 163. When this arrangement is used, as shown in FIG. 16(B), when magnetic panel edges are placed adjacent to one another, the cylindrical magnets 161 rotate to position their N and S poles in a mutually attracting position.

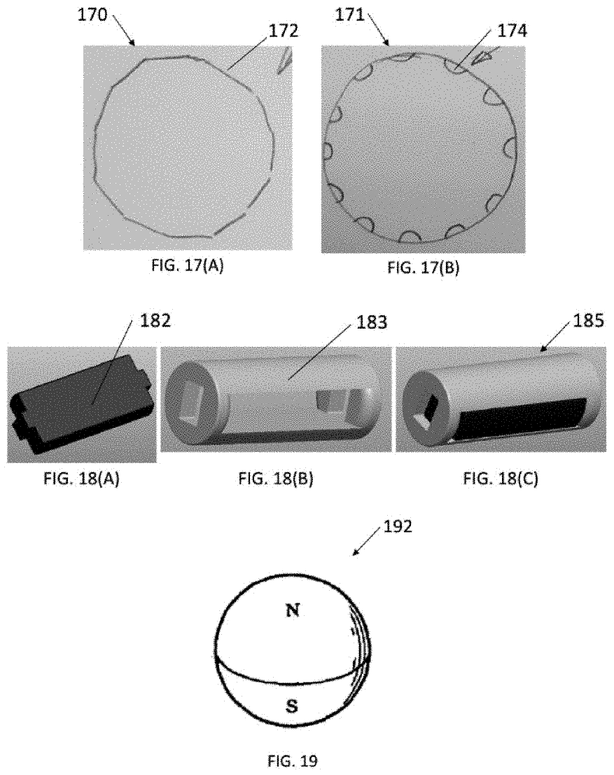

On other exemplary embodiments, other rotatable magnet configurations may be utilized, such as the multi-sided rotating magnet 170 with sides 172 depicted in FIG. 17(A) and the rotating magnet 171 with grooves 174 in FIG. 17(B). These configurations are non-cylindrical and therefore may be more easily installed to the panels during assembly, while also provide adjustable magnetic connections.

In another embodiment, a form of rotatable magnet can be provided where the rectangular magnet 182 depicted in FIG. 18(A) is arranged in the rotatable housing 183 depicted in FIG. 18(B) to provide the magnet assembly 185 depicted in FIG. 18(C). This arrangement allows a non-cylindrical magnet to provide adjustable magnetic connections.

In another exemplary embodiment, a magnet of any shape may be provided in a volume created by magnet pocket 135 and allowed free movement within the magnet pocket to provide adjustable magnetic connections.

In another exemplary embodiment, spherical magnets are used, such as spherical magnet 192 shown in FIG. 19. In such a configuration, the magnet pockets 135 would be formed with a corresponding shape. When such spherical magnets are used, they align themselves in a fashion similar to the cylindrical magnets discussed above, but with a greater range of movement.

In still another exemplary embodiment, rectangular magnets are used. In one exemplary embodiment, the use of rectangular magnets allows magnetic attracting of the magnetic edges only when panels are contacted with a specific edge orientation. In another embodiment, rectangular magnets are arranged in a manner so that the magnetic edges may connect at any edge orientation. Exemplary manners for achieving a connection at any edge orientation include, but are not limited to, the use of two dual pole magnets or one or more multipole magnets per magnetic edge, as described in more detail below.

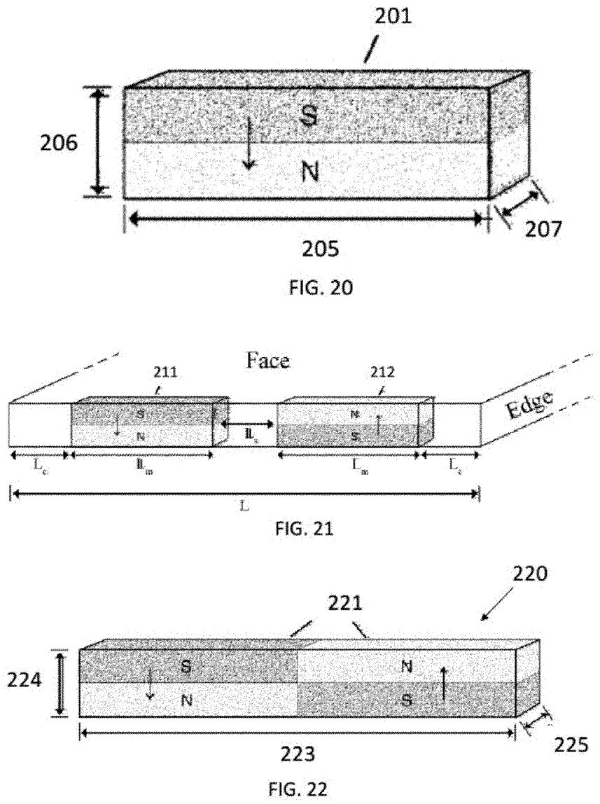

A “dual pole” magnet refers to a magnet that contains one pair of magnetic poles. A nonlimiting example of a dual pole magnet is shown in FIG. 20, which depicts a block magnet 201 with two poles (“N”) and (“S), with the magnetized direction S to N shown with an arrow. The block magnet has a length 205, a width 206, and a thickness 207, and magnetized direction through the width.

The rectangular “dual pole” magnet size and strength is selected to balance the need for panel connection to, for example, form scenes, structures, and vehicles, and the ability for users to pull the panels apart.

In some rectangular magnet embodiments, a magnetic edge contains an even number of dual pole magnets (e.g., two, four, etc.) disposed in alternating magnetic orientation along the edge, and in alternating orientation around the panel if more than one edge is magnetic.

One embodiment of such a panel edge is shown schematically in FIG. 21 with two dual pole block magnets 211, 212 embedded in an edge of a panel. Each block magnet is oriented with its length Lm parallel or substantially parallel to the edge of the panel and its width perpendicular or substantially perpendicular to the face of the panel, embedded to a depth of at least its thickness in the edge of the panel, and oriented with a magnetized direction S to N (shown by arrows) through the width and perpendicular to the length of the magnet, with magnets configured in alternating S to N magnetic orientation along the panel edge. In an embodiment in which all edges of the panel contain dual pole magnets, the magnets are configured with an even number of magnets per edge and in alternating magnetic orientation around the edges of the panel.

In the FIG. 21 embodiment, two dual pole block magnets 211 and 212 are configured in opposite, alternating magnetic orientation (indicated by arrows showing the magnetized directions through the magnets) on the edge of the panel. In some embodiments, the dual pole magnets are spaced symmetrically and/or a constant distance apart on each edge of a panel, or on each magnetic edge of the panels of the construction toy. For example, as shown in FIG. 21, where the total length of the panel edge is represented by L, the length of each magnet is Lm, the distance between magnets 211 and 212 is Ls, and the distance from each corner to the nearest magnet is Lc, L=2Lc+2Lm+Ls.

In some embodiments, all magnetic edges within a group of panels contain dual pole magnets in alternating magnetic orientation and symmetrically configured on the edge, with Lc, Lm, and Ls the same on each magnetic edge. In some embodiments, all edges of a panel are magnetic edges that contain dual pole magnets in alternating magnetic orientation and symmetrically configured on all edges, and in alternating magnetic orientation around the panel, with all Lc, all Lm, and all Ls lengths the same around the panel. In some embodiments, all magnetic edges within a group of panels contain dual pole magnets in alternating magnetic orientation with Ls the same on each magnetic edge, and Lm and Lc lengths the same or different. In some embodiments, all edges of a panel are magnetic edges that contain dual pole magnets in alternating magnetic orientation, and in alternating magnetic orientation around the panel, with Ls the same on each magnetic edge, and Lm and Lc lengths the same or different. In some embodiments, all magnetic edges within a group of panels contain dual pole magnets in alternating magnetic orientation with Lm and Ls the same on each magnetic edge, and Lc lengths the same or different. In some embodiments, all edges of a panel are magnetic edges that contain dual pole magnets in alternating magnetic orientation, and in alternating magnetic orientation around the panel, with Lm and Ls the same on each magnetic edge, and Lc lengths the same or different.

In some embodiments, a magnetic edge contains at least one multipole magnet that contains adjacent pairs of magnetic poles of opposite polarity, where the number of poles is equal to 4n and n is an integer≥1, with the magnet configured along the edge of the panel such that magnetized directions through each pair of poles are oriented with alternating polarity. A “multipole” magnet refers to a magnet that contains more than one pair of magnetic poles. A nonlimiting example of a multipole magnet is shown in FIG. 22. The multipole block magnet 220 depicted in FIG. 22 contains two pairs of poles (four poles, i.e., n=1) in alternating magnetic polarity. The multipole magnet has a length 223, a width 224, and a thickness 225, and alternating magnetized directions through the width. Two pairs of poles 221 are configured in alternating magnetic polarity S to N, indicated by arrows.

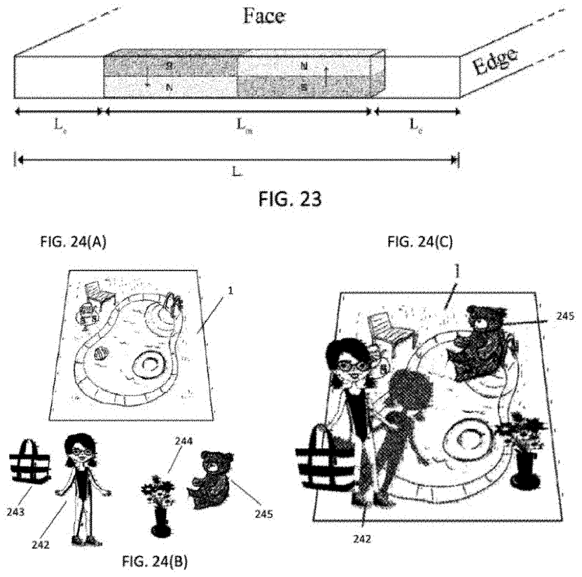

The rectangular “multipole” magnet size and strength is selected to balance the need for panel connection to, for example, form scenes, structures, and vehicles, and the ability for users to pull the panels apart. Any type of magnet may be used including, for example, Y35 and N45 magnets. The magnets are sized and spaced within the panel edges to provide appropriate magnetic properties. Examples of appropriate magnet sizes are 12 mm×3 mm×2 mm, 15 mm×3 mm×2 mm (for an N45 magnet), and 40 mm×4.5 mm×2 mm (for a Y35 magnet).

Where more than one multipole magnet is embedded in an edge of a panel or where more than one edge of a panel contains the multipole magnets with pairs of magnetic poles of opposite polarity, where the number of poles is equal to 4n and n is an integer≥1, the magnets are disposed along the edge or around the panel in the same orientation of polarity. This is shown schematically in FIG. 23.

In one embodiment, shown in FIG. 23, one multipole block magnet with 4n magnetic poles in pairs of poles of opposite polarity, where n is an integer≥1, is configured on the edge of a panel. In other embodiments, more than one of the multipole magnets may be configured on the edge of a panel, with the multipole magnets configured in the same magnetic orientation. In embodiments in which the multipole magnets are on each edge of a panel, they are configured in the same magnetic orientation around the panel. For example, FIG. 23 shows magnetic edges with two of the multipole magnets (e.g., 20 and 21) configured on a panel edge in the same magnetic orientation, and in the same orientation around the panel. In the embodiments depicted in FIGS. 6 and 23, a multipole magnet is configured with its length parallel or substantially parallel to the edge of the panel, with its width perpendicular or substantially perpendicular to the face of the panel and embedded to a depth of at least its thickness in the edge of the panel. The magnet contains pairs of poles disposed along the length of the magnet with alternating magnetized directions through the width of the magnet and perpendicular to its length.

In some embodiments, the multipole magnet(s) with 4n magnetic poles in pairs of poles of opposite magnetic polarity, where n is an integer≥1, are spaced symmetrically and/or a constant distance apart on each edge of a panel, or on each magnetic edge of the panels of the construction toy. For example, where the total length of the panel edge is represented by L, the length of each magnet is Lm, the distance between magnets on a panel edge is Ls, and the distance from each corner to the nearest magnet is Lc, L=2Lc+nLm+(n−1) Ls, where n is the number of magnets on the panel edge. In some embodiments, all magnetic edges within a group of panels contain the multipole magnets symmetrically configured on the edge, with Lc, Lm, and Ls the same on each magnetic edge. In some embodiments, all edges of a panel are magnetic edges that contain the multipole magnets symmetrically configured on all edges with all Lc, all Lm, and all Ls lengths the same around the panel, and with the magnets in the same magnetic orientation around the panel. In some embodiments, all magnetic edges within a group of panels contain the multipole magnets with Ls the same on each magnetic edge, and Lm and Lc lengths the same or different. In some embodiments, all edges of a panel are magnetic edges that contain the multipole magnets with Ls the same on each magnetic edge, and Lm and Le lengths the same or different, and with the magnets configured in the same magnetic orientation around the panel. In some embodiments, all magnetic edges within a group of panels contains the multipole magnets with Lm the same. In some embodiments, all magnetic edges within a group of panels contain the multipole magnets with Lm the same and Ls and Lc lengths the same or different. In some embodiments, all edges of a panel are magnetic edges that contain the multipole magnets with Lm the same and Ls and Lc lengths the same or different, and with the magnets configured in the same magnetic orientation around the panel.

In some embodiments, a magnetic edge contains an even number of multipole magnets (e.g., multipole block magnets) that each contains an odd number of pairs of poles of opposite polarity. Each magnet is oriented along the edge of the panel with alternating magnetized directions through the pairs of poles and perpendicular to the panel edge, and the magnets are configured with alternating orientation of polarity with respect to one another along the panel edge. The multipole magnets may be configured with their lengths parallel or substantially parallel to the edge of the panel, with their widths perpendicular or substantially perpendicular to the face of the panel, and embedded to depths of at least their thicknesses in the edge of the panel. Each magnet contains an odd number of pairs of poles disposed along the length of the magnet with alternating magnetized directions through the width of the magnet and perpendicular to its length. In some embodiments, an even number of the multipole magnets is spaced symmetrically and/or a constant distance apart on each edge of a panel, or on each magnetic edge of the panels of the construction toy, with the multipole magnets disposed around a panel in alternating orientation of polarity.

### Accessory Items

Accessory items may optionally be used in conjunction with the building toy described herein to enhance play.

Accessory items may be designed to be moved from one location to another within the constructed scene, structure, or vehicle, or may be designed as stationary embellishments that connectively attach at a specific location on a panel. Nonlimiting examples of accessory items include human and animal figures, furniture, clothing, food, tools, appliances, bags or other containers, scenery embellishments (e.g., trees, flowers), vehicles, light fixtures, and weapons.

In some embodiments, accessory items include items that may attach or adhere to panel face(s) including, but not limited to, by magnetic attraction, adhesively, by static electricity, or mechanically (e.g., a hook, a rod that fits into an opening, etc.). Accessory items may also simply rest on or next to panel faces.

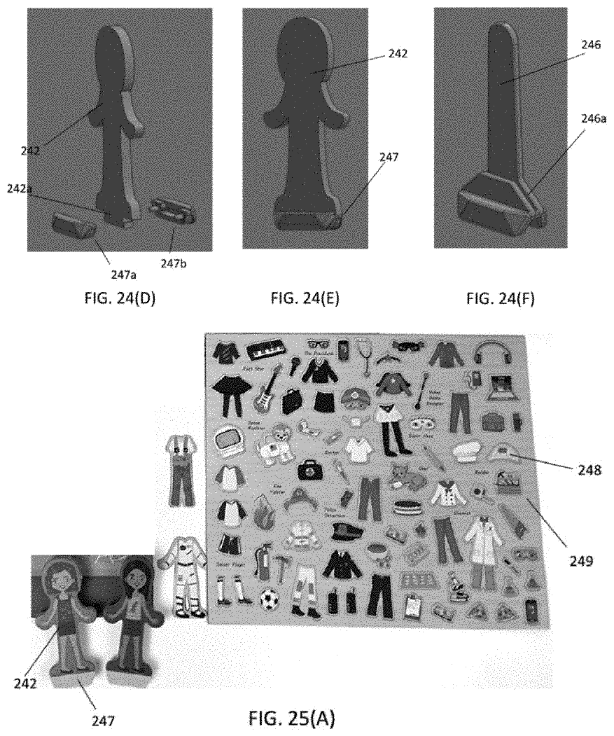

In exemplary embodiments, accessories may include a doll 242, bag 243, vase 244, and teddy bear 245, as shown in FIG. 24(B). These accessories may be two dimensional (e.g., sheets) or three dimensional (e.g., molded three dimensional forms or two dimensional forms with removable stands). Each of these accessories may be utilized alone, in conjunction with one or more panels, or in conjunction with any of the scenes, structures, or vehicles described herein.

In one exemplary embodiment, as shown in FIG. 24(C), panel 1 with pool is arranged horizontally, and doll 242, vase 244, and teddy bear 245 are arranged thereon. In this exemplary embodiment, vase 244 and teddy bear 245 are two dimensional such that they lay flat on panel 1. Additionally, in this exemplary embodiment, vase 244 and teddy bear 245 are magnetically connected to panel 1. In other exemplary embodiments, accessories may simply lay on panel 1, or be connected to panel 1 in any manner described herein. For example, the accessory item may be magnetic or magnetically receptive such that it may be magnetically attracted to a magnetic receptive or magnetic connective face, respectively. An accessory item may contain one or more magnetic or magnetic receptive surface(s). An accessory item may optionally be configured so that the item may be magnetically attached to panel faces in a number of different orientations.

In the exemplary embodiment of FIG. 24(C), doll 242 is configured to stand on its own and project outward from panel 1. Doll 242 may be provided with features that allow it to independently stand, such as base 247 or stand 246, as shown in FIGS. 24(D). When no base 247 or stand 246 is used, doll 242 may simply rest on or next to panel 1, or may be connected to panel 1 in any manner described herein. When base 247 or stand 246 is used, doll 242 may stand on or next to panel 1. Base 247 or stand 246 may also be configured to connect to panel 1 in any manner described herein. Dolls 242 can also be made with integral features that allow it to stand.

In exemplary embodiments, dolls 242 can represent people or animals, and can be made of any suitable material, such as wood or plastic. Dolls 242 may be scaled so that users can play with them within the scenes, structures, or vehicles described herein, or may be scaled for independent play.

As described above, dolls 242 may be equipped with a feature that permits the doll 242 to stand upright. The feature can be integrally formed with the doll, or can be removable. Examples of removable features are illustrated in FIGS. 24(D)-(F). FIGS. 24(D) and (E) illustrate a two-piece base 247 that a user may connect around the bottom of doll 242 via any suitable means. By way of example, the portions 247a and 247b of base 247 can be connected by an interference or snap fit. Features may also be provided in a two-piece base to prevent the doll 242 from being vertically removed from base 247 when portions 247a and 247b are connected. For example, in the embodiment shown in FIGS. 24(D) and (E), the inner surfaces of portions 247a and 247b of base 247 are shaped to surround the retention feature 242a at the bottom of doll 242. A one-piece base configuration that interfaces with retention feature 242a using a cup-like feature may also be provided. FIG. 24(F) illustrates an exemplary embodiment of a stand 246. In this embodiment, the bottom portions of a doll 242 may simply be inserted into retention feature 246a, which is dimensioned such to provide sufficient retention for doll 242.

In exemplary embodiments, doll 242 may be provided with connective features as described herein that allow it to be connected to panel faces and to allow other accessory items to be attached to doll 242. For example, doll 242 may be configured to allow other accessories to attach or adhere to doll 242 by magnetic attraction, adhesively, by static electricity, or mechanically (e.g., a hook, a rod that fits into an opening, etc.). In the exemplary embodiment shown in FIG. 24(C), doll 242 has a magnetic surface that allows a user to add other accessories, such as bag 243, to enhance play.

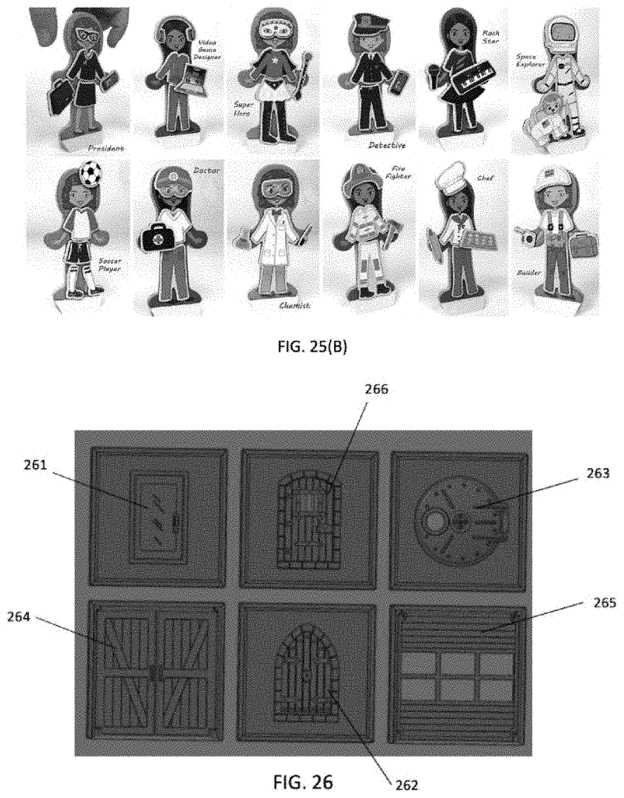

Accessories 248 may be provided on a removable sheet 249, as shown in FIG. 25(A). In this exemplary embodiment, these accessories may be used to dress dolls 242.

In exemplary embodiments, dolls 242 may be dressed using accessories to provide various characters, as shown in FIG. 25(B).

In some embodiments, an accessory item may include moving parts and optionally, a motor, and may be powered, for example, via a battery or electricity. Nonlimiting examples of such accessory items include a fan that spins, a light fixture that lights up, a crane that pivots, or a motile human or animal figure.

### Alternative Panel Configurations

In some embodiments, panels may include openings. Openings may include passageways, fixed doors, and movable doors. The openings may be provided in conjunction with any of the panel face types (e.g., unadorned, connective, illustrated, or decoratable) disclosed herein, in whole or in part.

Several exemplary embodiments of openings are depicted in FIG. 26, such as a door 261, a drawbridge 262, an airlock 263, a barn door 264, a garage door 265, and a dungeon door 266. These examples are non-limiting and any opening usable with the scenes, structures, or vehicles envisaged herein are suitable.

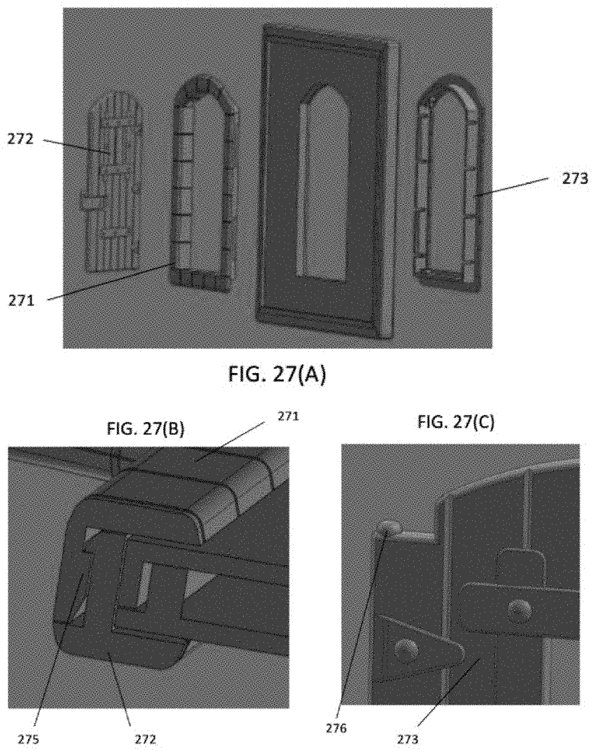

In embodiments where the opening is a movable door (e.g., a door that may be opened and closed), the movable door may be constructed, in an exemplary embodiment, with a front frame 271, back frame 273, and door 272 mounted about plates 101 and 102 of a panel, as depicted in FIG. 27(A).

In the exemplary embodiment of FIG. 27(A), front frame 271 and back frame 272 may be attached to each other and/or one or more of plates 101, 102 in any suitable manner. For example, the front 271 and back 272 frames may be snapped and glued together at interface 275. In this embodiment, door 273 may be pivotally attached to any of the front frame 271, back frame 272, or plates 101, 102. For example, as shown in FIGS. 27(A)-(C), the door 273 pivots on two interface points 276 with front frame 271. In one embodiment, the retention force of interface points 276 is set so that doors disconnect from interface points 276 before they plastically deform or break.

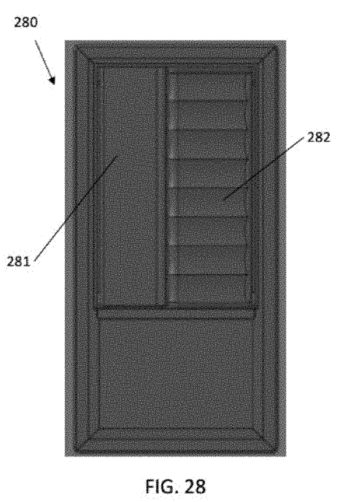

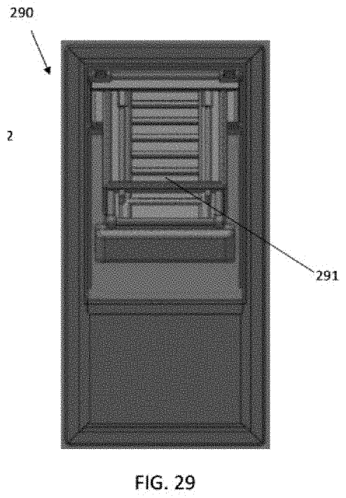

More exemplary embodiments of openings are depicted in FIGS. 28 and 29. As shown in FIG. 28, multiple doors 281, 282 can be provided in an opening. In this embodiment, pivot points are provided on opposite sides of the opening.

Instead of a door, an additional play element may also be provided in the opening. The additional play element is representative of a mechanical attachment or tool, such as a fire hose, crane, turret, or any other attachment that can normally be found on a vehicle. The attachment may be articulatable in one direction (e.g., along a hinge point) or in multiple directions (e.g., along a hinge point and with an adjustable length). In the exemplary embodiment shown in FIG. 29, the additional play element is a ladder 291 connected on hinge points near the top of the opening in panel 290 to swing along the hinge point, and may be extendable.

### Additional Vehicles

In addition to the vehicle base structures discussed above, additional vehicles are usable with the panels and accessories discussed herein.

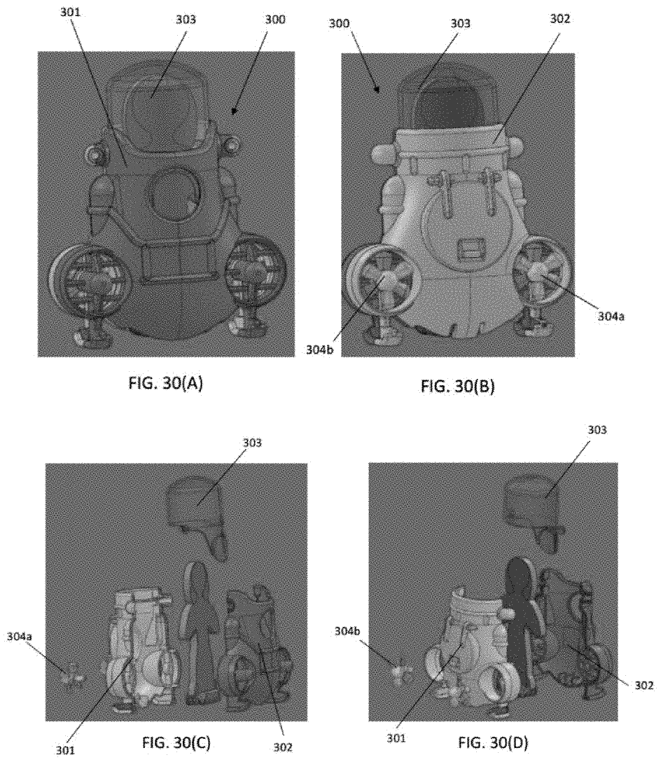

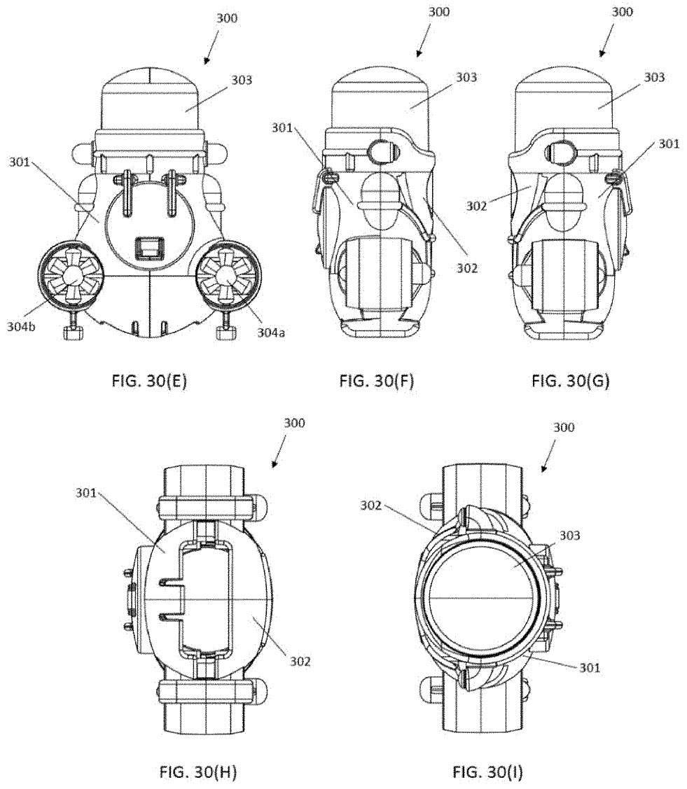

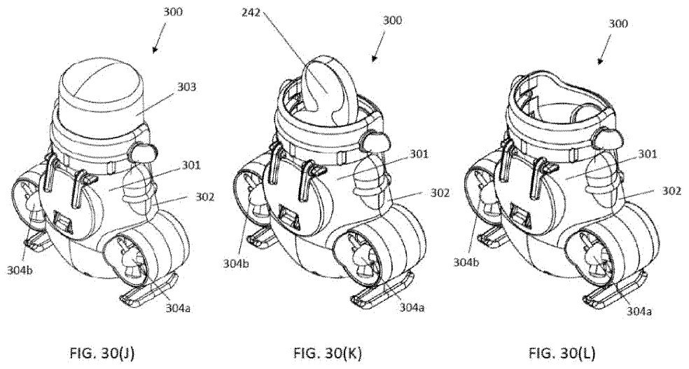

In one exemplary embodiment, a submersible is provided. As shown in FIGS. 30(A)-30(L), the submersible 300 is made of a front half 301, a back half 302, a clear top 303 with clear lower window 303a, and two propellers 304a, 304b. When the submersible 300 is assembled, the propellers 304a, 304b are screwed into the front half, the screws are trapped between the two halves 301, 302, and the two halves 301, 302 are affixed to each other in any suitable manner, such as by glue or ultrasonic weld.

The clear top 303 is removable to allow access to the submersible interior. A doll, such as doll 242 discussed above as an accessory, fits inside the submersible 300 so that the doll's head is visible in the clear top 303. The clear top 303 is releasably retained to the submersible 300 in any suitable manner, such as by snap features.

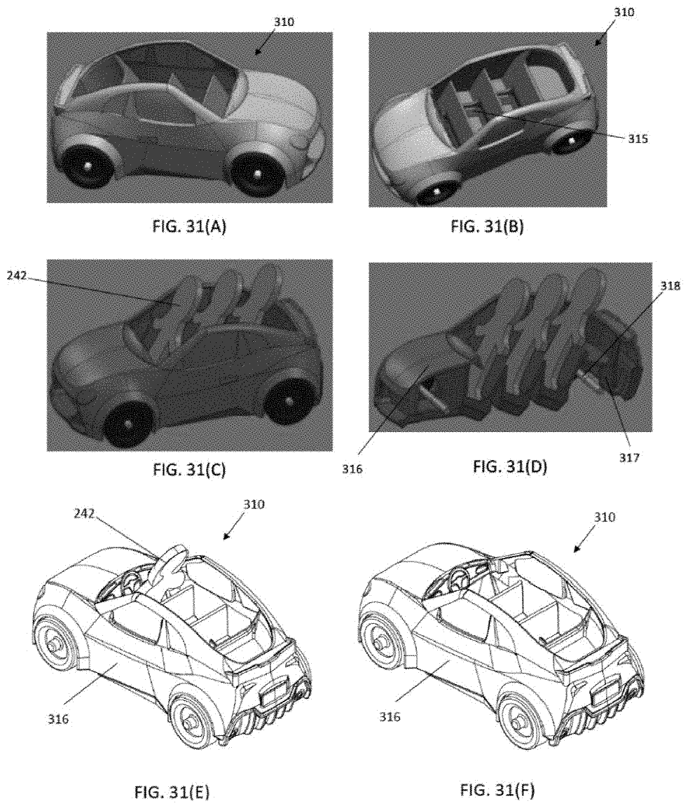

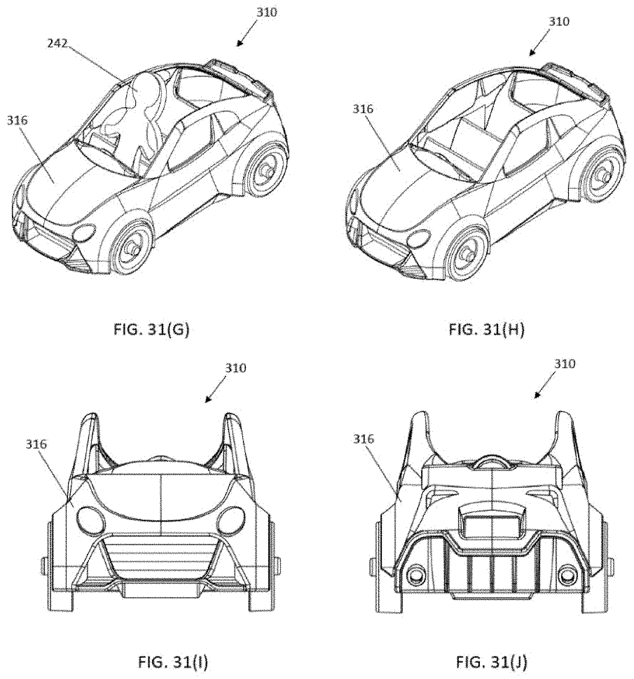

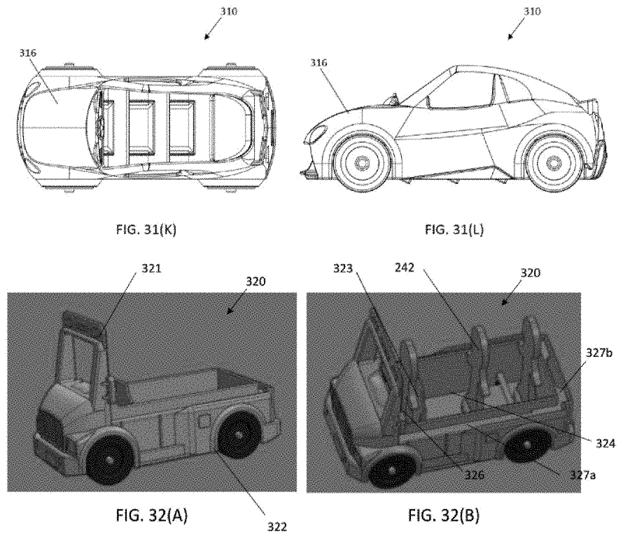

In another exemplary embodiment, a car 310 is provided. As shown in FIGS. 31(A)-31(F), the car 310 is made of a top part 316 and a bottom part 317, with the wheels and axles 318 trapped therebetween. The top 316 and bottom 317 are affixed to each other in any suitable manner, such as by glue or ultrasonic weld. As shown in FIG. 31(C), the car 310 may fit up to three dolls 242 in its seats 315. The dolls 242 may fit at an angle to allow them to remain relatively stationary and upright during play.

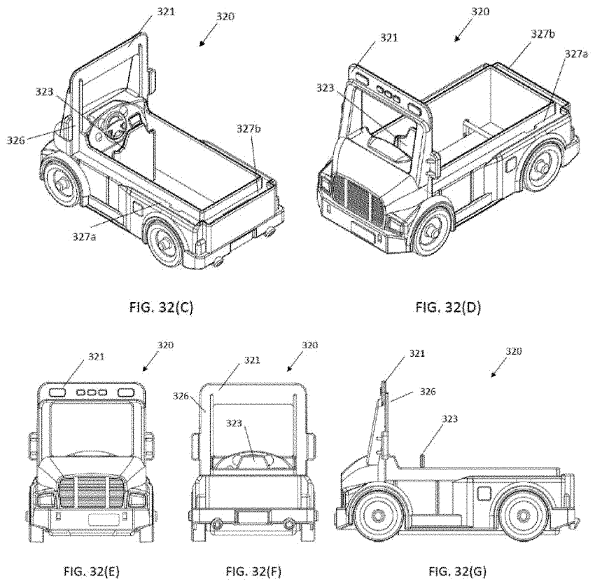

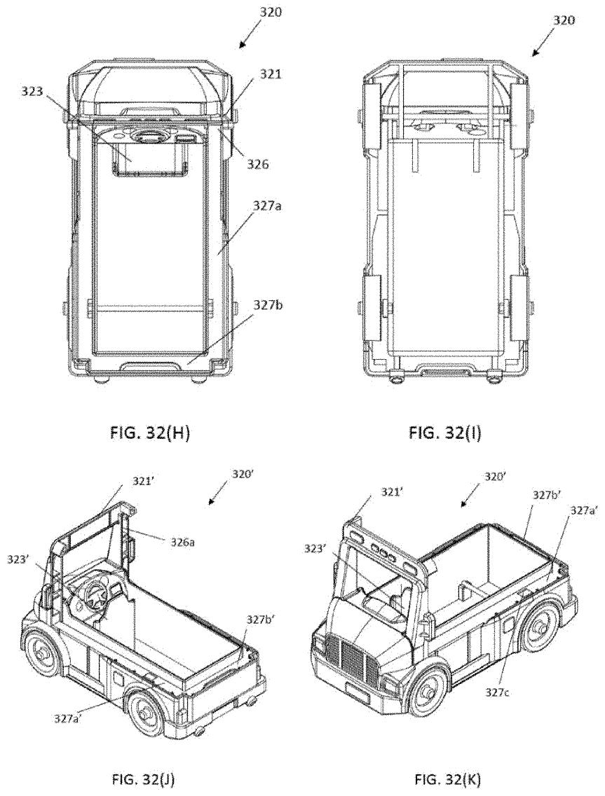

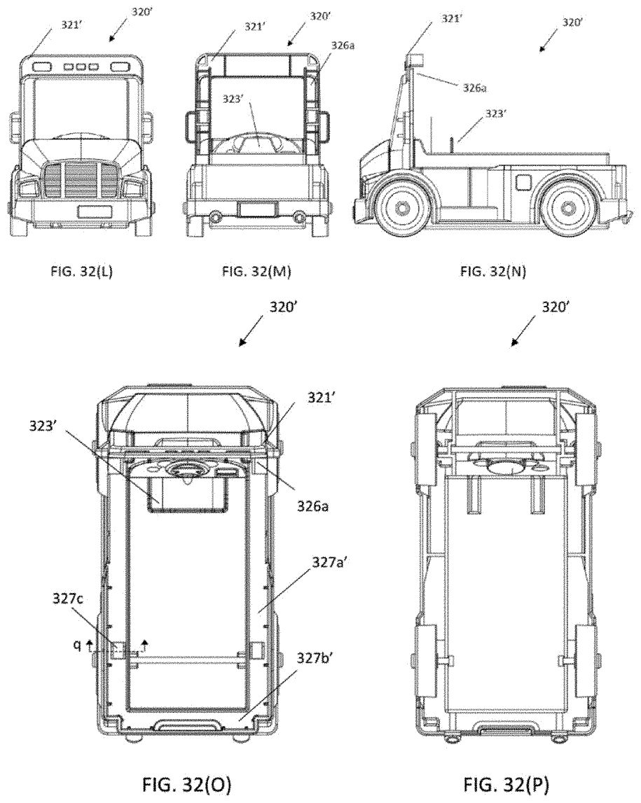

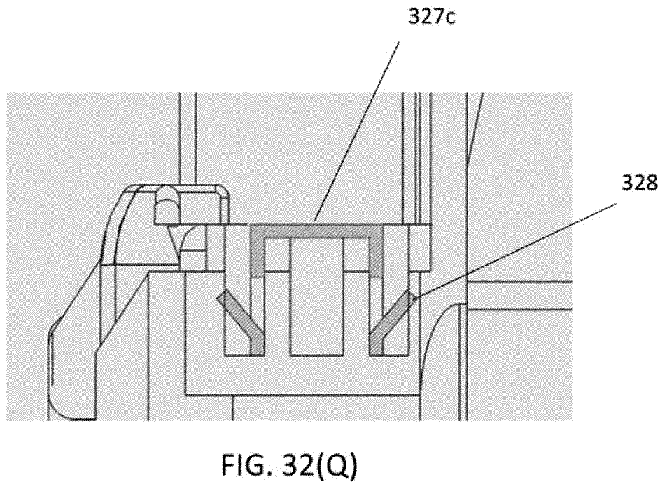

In another exemplary embodiment, a truck 320 is provided. As shown in FIGS. 32(A)-32(P), the truck is made of a top part 321 and a bottom part 322, with the wheels and axles trapped therebetween in a fashion similar to car 310 described above. The car top 321 and bottom 322 are affixed to each other in any suitable manner, such as by glue or ultrasonic weld. As shown in FIG. 32(B), the driver position of the truck 323 may fit one doll 242 in a similar fashion as described above with the car 310, while the back 324 of the truck may hold additional dolls 242 in a loose arrangement.

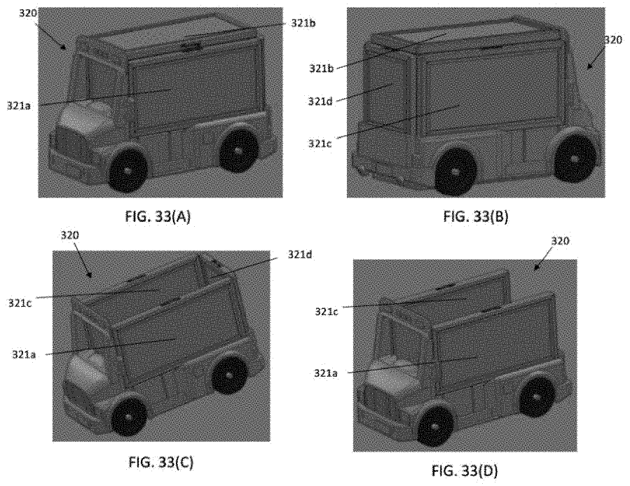

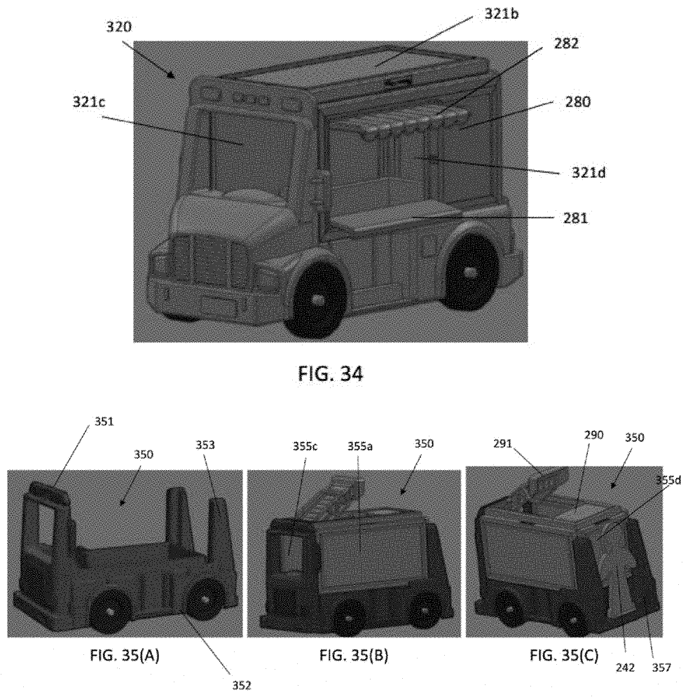

In an exemplary embodiment, the truck 320 is provided with panels and functions like a base structure discussed above. As shown in FIGS. 33(A)-33(D), the truck 320 can be modified into many different configurations by magnetically or mechanically attaching one or more panels 321a-321d. As discussed above, the panels can be unadorned, connective, illustrated, or decoratable. Illustrated panels 321a-321d can be provided that identify different types of trucks, such as a school bus, food truck, work truck, dump truck, ambulance, farm truck, or animal rescue truck.

In another exemplary embodiment, a truck 320 is provided with panels 321 as discussed above. In addition, panel 280 with doors 281, 282 is arranged to provide a foot-truck type configuration.

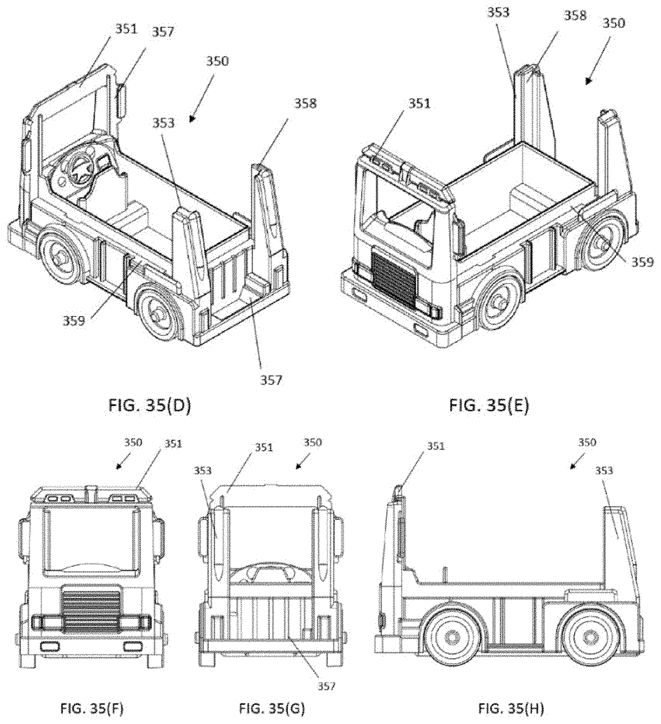

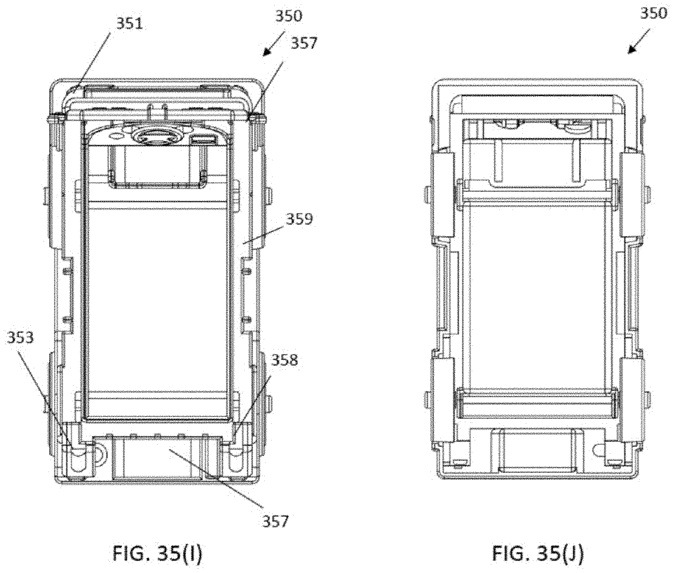

Another exemplary embodiment of a truck that functions like a base structure discussed above is shown in FIGS. 35(A)-35(J). In this embodiment, the truck can be formed into a fire truck 350 with upper 351 and lower 352 halves. Panels 355a, 355c, 355d provide the sides of fire truck 350, and panel 290 with ladder 291 provides the top of fire truck 350. Like the truck above, fire truck 350 has room for one doll in the front, multiple dolls in the rear, and one doll 242 on the rear bumper 357.

As described above, panels may be connected to vehicles, such as the exemplary trucks shown in FIGS. 32(A)-(P), 33(A)-(D), 34, and 35(A)-(J) using magnetic features, mechanical features, or a combination of magnetic and mechanical features.

For example, in the truck shown in FIGS. 32(A)-(K) and 33(A)-(D), panels 321a-321d magnetically connect to each other along their edges as shown, and are mechanically retained to the truck by U-shaped features 327a and 327b along the upper edges of the rear sides of truck 320 and L-shaped features 326 along the rear vertical edges of the windshield frame of truck 320. These features interface with the edges of panels 321a, b, and c when those panels are magnetically connected to each other to provide retention on truck 320 and stability for the shape of panels 321a-d. While U-shaped features are shown, any suitable retention feature may be utilized, such as tabs. As illustrated in FIGS. 32(A)-(K) and 33(A)-(D), the U-shapes do not necessarily extend along the entire upper edges of the rear sides and rear vertical edges of the windshield frame of truck 320. The dimensions of these features may be selected to provide sufficient retention.

In the alternative embodiment of FIGS. 32(J)-32(Q), small metal panels 327c are provided on the upper edges of the rear sides of truck 320, although such panels can be placed at any appropriate area and be formed in any appropriate shape. Metal panels 327c are arranged to provide, in this embodiment, a magnetic connection for panels 321a, 321c, as shown in FIGS. 33(A)-33(D), to provide a stronger connection for the structure formed by panels 321a-321d. Due to the provision of these metal plates 327c, the U-shaped features 327a′ and 327b′ are made smaller than the comparable elements in the embodiments of FIGS. 32(A)-(K). Similarly, L-shaped features 326 are deleted, leaving the rear core structure 326a of the windshield frame visible.

Metal panels 327c may be attached to truck 320 in any suitable manner. In one exemplary embodiment, metal panels 327c are glued to truck 320. In another exemplary embodiment, as shown in FIG. 32(Q) metal plate 327c has barbs 328 that interface with surfaces of truck 320 to retain metal panel 327c. In another embodiment, metal plates 327c are retained by both barns 328 and glue. Metal panels 320 may also be countersunk in the surface of truck 320 to prevent pull-out by a user.

As a further alternative, a suitable magnet, such as the magnet designs described herein or other features that provide a magnetic connection, may be provided in the truck structure to provide connection to the panels.

Similar features may be utilized in any other vehicle configuration, such as the truck shown in FIGS. 35(A)-(J). In the exemplary embodiment shown in these figures, U-shaped features are provided along the upper edges 359 of the rear sides of truck 350 and L-shaped features are provided along the rear vertical edges 357 of the windshield frame and the front vertical edges 358 of the rear frame 353. Metal plates or magnets described above may also be used in this embodiment, with corresponding changes to the U- and L-shaped features.

Beyond the exemplary embodiments described herein, any suitable combination of the retention features, metal plates, and magnets may be used to provide the desired connection strength, which can be balanced between the strength necessary to maintain the shape of the truck features and the strength low enough so that the truck feature collapse for safety, such as when a user falls on the truck.

### Play Sets

To enhance play, various play sets may be provided. Each play set may have a number of components that have a special shape and graphics according to a particular theme. Exemplary play sets may include: (1) “Career Dolls,” with two dolls and a sheet setting; (2) “Fashion Friends,” with two dolls and a sheet setting; (3) “Food Truck,” with two dolls, one truck chassis, and four panels, including one rectangular panel with double door insert; (4) “Safari Rescue Truck,” with one doll, three animals, one truck chassis, five rectangular panels, and one small square panel; (5) “Draw & Build Dollhouse,” with two dolls, three large dry erase square panels, one large dry erase square panel with drawbridge, and one small dry erase triangle panels; (6) “Draw & Build Castle,” with two dolls, three large dry erase square panels, one large dry erase square panel with door, two large dry erase triangle panels, and two small dry erase triangle panels; (7) “Underwater Explorers,” with two dolls, one animal, five large square panels, one large square panel with airlock, four large triangle panels, and one submarine; (8) “Pirate Cove,” with two dolls, one animal, four large square panels, three large triangle panels, two rectangular panels, and one ship; (9) “Pizza/Ice Cream Parlor,” with two dolls, two doll stands, four large square panels, two large triangle panels, one rectangle panel, one rectangle panel with double door, one small square panel, and one truck; (10) “Fire Station,” with two dolls, two doll stands, one animal, four large square panels, one large panel with garage door, two large triangle panels, two small triangle panels, two rectangle panels, one rectangle panel with ladder, one small square panel, and one truck; (11) “Pet center,” with two dolls, two doll stands, three animals, six large squares, one large triangle, two small triangles, three rectangles, one small square, and one truck; (12) “Creativity Castle,” with two dolls, three doll stands, seven large squares, one large square with drawbridge, two large triangles, two small triangles, and two rectangles; (13) “Barn,” with two dolls, two doll stands, four animals, two large squares, four large triangles, three small triangles, five rectangles, one small square, and one truck; (14) “Hospital,” with two dolls, two doll stands, six large squares, three large triangles, five rectangles, one small square, and one truck; (15) “School,” with six dolls, two doll stands, five large squares, two large triangles, six rectangles, one small square, and one truck; and (16) “Malia's house,” with three dolls, nine large squares, two large triangles, two rectangles, two small triangles, and one car. These themes may include additional panels, accessories, base structures, and vehicles to further enhance play.

All the elements described herein are intended, where possible, to be used interchangeably with existing “Build and Imagine” panels and accessories as of the filing date of this Application.

All publications, patents, and patent applications cited herein are hereby incorporated by reference in their entireties for all purposes and to the same extent as if each individual publication, patent, or patent application were specifically and individually indicated to be so incorporated by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims. Therefore, the description should not be construed as limiting the scope of the invention.

1. A panel for a construction toy, comprising:
a top plate comprising a top face side having a top outer peripheral edge portion and a core side having a top outer peripheral flange;
a bottom plate comprising a bottom face side having a bottom outer peripheral edge portion, wherein the bottom outer peripheral edge portion is joined with the top plate at least along the top outer peripheral flange;
a first U-shaped edge portion comprising an outer surface and an inner channel, said inner channel of the first U-shaped edge portion extending along and shaped to interface with the top outer peripheral flange, wherein the inner channel and the top outer peripheral flange form a magnetic pocket having a volume defined at least partially by the inner channel and said top outer peripheral flange;
at least one magnet arranged in the magnetic pocket;
wherein the inner channel comprises a first side wall that extends along and at least partially covers the outer peripheral edge portion of the top plate, and a second side wall that extends along and at least partially covers the outer peripheral edge portion of the bottom plate.

2. The panel of claim 1, wherein the top outer peripheral flange comprises a top bonding surface and a bottom bonding surface and wherein the first wall of the inner channel is bonded to the top bonding surface in a plane parallel to the face side of the top plate and the second wall of the inner channel is bonded to the bottom bonding surface in a plane parallel to the face side of the bottom plate.

3. The panel of claim 1, wherein the bottom plate comprises a bottom outer peripheral flange and wherein an outer face of the bottom outer peripheral flange of the bottom plate is in contact with an inner face of the top outer peripheral flange of the top plate in a plane perpendicular to the face side of the top plate and the face side of the bottom plate.

4. The panel of claim 2, wherein the bottom plate comprises a bottom outer peripheral flange and wherein an outer face of the bottom outer peripheral flange of the bottom plate is in contact with an inner face of the top outer peripheral flange of the top plate in a plane perpendicular to the face side of the top plate and the face side of the bottom plate.

5. The panel of claim 1, wherein the U-shaped portion comprises a first female connector disposed within the inner channel; and an outer face of the top outer peripheral flange of the top plate comprises a first male connector inserted into the first female connector on the first U-shaped portion.

6. The panel of claim 2, wherein the first U-shaped portion comprises a first female connector disposed within the inner channel; and an outer face of the top outer peripheral flange of the top plate comprises a first male connector inserted into the first female connector on the first U-shaped portion.

7. The panel of claim 1, further comprising a second U-shaped edge portion, wherein the first U-shaped portion comprises a first male interlock element at an end of the first U-shaped portion, wherein the second U-shaped portion comprises a first female interlock element disposed at an end of the second U-shaped portion, and wherein the first male interlock element is inserted into the first female interlock element.

8. The panel of claim 2, further comprising a second U-shaped edge portion, wherein the first U-shaped portion comprises a first male interlock element at an end of the first U-shaped portion, wherein the second U-shaped portion comprises a first female interlock element at an end of the second U-shaped portion, and wherein the first male interlock element is inserted into the first female interlock element.

9. The panel of claim 1, wherein an outer face of the top outer peripheral flange comprises a rib that at least partially defines said magnetic pocket; and the magnet is permanently affixed to the rib.

10. The panel of claim 2, wherein an outer face of the top outer peripheral flange comprises a rib that at least partially defines said magnetic pocket; and the magnet is permanently affixed to the rib.

11. The panel of claim 1, wherein the first panel further comprises
an opening extending between the top face side and the bottom face side;
a retention member arranged along the perimeter of the opening; and
a play element connected to said retention member.

12. The panel of claim 11, wherein the connection of the play element to the retention member allows the play element to be articulatable in at least one direction, and wherein the play element is a door, a window, or an awning of a simulated structure or a simulated vehicle.

13. (canceled)

14. The panel of claim 1, wherein the first and second panels form a structural feature of the vehicle.

15. The panel of claim 14, wherein the vehicle is a truck, a car, a submarine, or a boat.

16. (canceled)

17. (canceled)

18. A panel for a construction toy comprising:
a face plate comprised of a face surface and a face peripheral flange disposed along at least one edge of the face surface, the face peripheral flange having a proximal flange surface and a distal flange surface;
a U-shaped member, the U-shaped member comprising an edge portion, two leg portions extending from the edge portion, and one or more magnet receiving pockets between the leg portions; and
one or more magnets disposed in respective ones of the magnetic receiving pockets,
wherein a portion of the leg portions are affixed to respective ones of the proximal flange surface and distal flange surface.

19. The panel of claim 18, further comprising a back plate comprising:
a back surface and a back peripheral flange, wherein the back peripheral flange is disposed along at least one edge of the back surface, wherein an outer face of the back peripheral flange is joined with an inner face of the face peripheral flange, and wherein the back plate is joined with the front plate.

20. The panel of claim 19, wherein the proximal flange surface extends proximal of the face surface and the distal flange surface extends distal of the back surface.

21. The panel of claim 20, wherein the leg portions extend along the respective proximal flange surface and distal flange surface and overlap, but do not contact, at least a portion of the face surface and back surface.

22. The panel of claim 18, wherein the magnet is rotatably held in the receiving pocket.

23. A method of assembling a panel of a construction toy comprising:
providing a face plate comprised of a face surface and a face peripheral flange disposed along at least one edge of the face surface, the face peripheral flange having a proximal flange surface and a distal flange surface;
providing a U-shaped member, the U-shaped member comprising an edge portion, two leg portions extending from the edge portion, and one or more magnet receiving pockets between the leg portions;
providing a back plate comprised of a back surface and a back peripheral flange, wherein the back peripheral flange is disposed along at least one edge of the back surface;
bonding an outer face of the back peripheral flange with an inner face of the face peripheral flange to form a panel;
bonding one or more magnets to inside surfaces of respective ones of the magnet receiving pockets; and
connecting respective ones of the leg portions to the proximal flange surface and the distal flange surface, wherein the magnets are enclosed between the edge portion of the U-shaped member and the face peripheral flange.

24. A panel for a construction toy comprising:
a plate, the plate comprising a retention wall along a side and a front face and a back face;
an edge, the edge comprising a U-shaped channel; and
one or more magnets,
wherein legs of the channel connect with respective front and back faces of the plate and wherein the retention wall and legs form a magnet retaining pocket.
